(19) United States
(12) Patent Application Publication
(10) Pub. No.: US 2013/0315130 A1
(43) Pub. Date: Nov. 28, 2013

(54) MOBILE COMMUNICATION SYSTEM, BASE STATION DEVICE, SGSN, AND MOBILE STATION DEVICE

(71) Applicants: Masayuki Enomoto, Osaka-shi (JP); Katsuyuki Machino, Osaka-shi (JP); Junji Hiraide, Osaka-shi (JP); Masafumi Aramoto, Osaka-shi (JP)

(72) Inventors: Masayuki Enomoto, Osaka-shi (JP); Katsuyuki Machino, Osaka-shi (JP); Junji Hiraide, Osaka-shi (JP); Masafumi Aramoto, Osaka-shi (JP)

(73) Assignee: SHARP KABUSHIKI KAISHA, Osaka-shi, Osaka (JP)

(21) Appl. No.: 13/984,898

(22) PCT Filed: Feb. 16, 2012
(86) PCT No.: PCT/JP2012/053623

§ 371 Date: Aug. 12, 2013

(30) Foreign Application Priority Data
Feb. 16, 2011 (JP) 2011-031309

(51) Int. Cl. H04W 72/00

(52) U.S. Cl. CPC H04W 72/005
USPC 370/312

(57) ABSTRACT

With an MBMS bearer service, information about an MBMS bearer which allocates and establishes MBMS bearer resources is included in an MBMS bearer context, with a base station device (NB) transmitting a confirmation message containing a service identifier to mobile station devices (UE) and, based on responses from the mobile station devices (UE), counting the number of mobile station devices (UE) participating in multicast data distribution. In the event that the number counted is 0, an MBMS registration deletion request for the multicast data is transmitted to an SGSN. Thus, by stipulating a control method using the counting function of the base station device to efficiently allocate network resources, a mobile communication system or the like capable of effectively using the network resources can be provided.

### TECHNICAL FIELD

The present invention relates to a mobile communication system or the like configured to perform multicast data distribution using a mobile station device to be connected to a base station device via a GGSN and an SGSN where an MBMS bearer is established from a BM-SC.

### BACKGROUND ART

With 3GPP, an MBMS (Multimedia Broadcast/Multicast Service) has been standardized as a method for providing an MBMS bearer service for performing multicast data distribution and broadcast data distribution using a GPRS (General Packet Radio Service).

For example, according to NPL 1, an MBMS service area is defined as a range where an MBMS session is performed. For example, a service area is set in increments of districts such as nationwide, Kanto area, or the like, a mobile communication system is configured of cells of multiple base station devices within this service area. A multicast distribution route is set over a wireless access network such as UTRAN or the like to be connected to a core network, the base station device (NodeB, NB) of each cell within the service area, or a radio network controller (RNC) sets an MBMS bearer to a terminal (UE), and distributes data.

Now, at the time of starting an MBMS service, first, MBMS registration has to be performed. MBMS registration mentioned here is to create a distribution list where distribution destination devices are described at a device which performs data distribution.

With MBMS registration, a distribution list is created at a device within a radio access network, or a device within a core network such as URTRAN or the like. Thus, an MBMS session is started after performing MBMS registration, and accordingly, a mobile station device can receive data from a distribution source device via multiple devices.

With such multicast data distribution according to the related art, multicast data is distributed not in increments of cells of base station devices but in increments of MBMS service areas. Therefore, in the event that there is a cell having no terminal to which multicast data is distributed within an MBMS service area as well, multicast data is distributed to the base station device of the cell thereof.

It is expected that such a multicast data distribution service will be diversified into various kinds such that broadcast services aimed at narrow ranges alone will also increase, in addition to broadcast services according to the related art with a relatively wide range service area.

Further, in the event that service modes are diversified into various kinds in this manner, it is expected that multicast data to be distributed is diversified to various uses from public use for widely distributing to personal community use and so forth, and the kinds thereof also markedly increase.

For example, as described in NPL 2, a use case such as a travel guide tour or the like has been described. Also, there can be conceived a multicast service with visitors to venues such as, for example, a sport or concert facility, a shopping center, and so forth. Further, there can also be conceived a case where information distribution is performed only as to victims of a disaster affected area.

Regardless of this trend of such service modes and distribution data to increase, all of communication paths such as an MBMS bearer or the like are established as to individual multicast distribution data in an integrated manner without being optimized, and data is distributed to a communication path regardless of whether or not there is a reception terminal. Thus, new problems occur such as increase in traffic, shortage of radio resources, and so forth.

In order to solve such problems, in recent years, a counting function for counting terminals which receive multicast data at a base station device, has started to be studied. In the event of having detected that a reception terminal is no longer present, the base station device effectively uses radio section resources, such as releasing the communication band of a radio link allocated for multicast data distribution between the base station device and the terminal, or by optimizing this by mode change or the like. Further, in the event that the terminal comes back, the base station device allocates radio resources thereto. Thus, study for effective use of radio resources using the counting function has been performed.

### CITATION LIST

### Non Patent Literature

NPL 1: TS 23.246, Technical Specification Group Services and Architecture; Multimedia Broadcast/Multicast Service (MBMS); Architecture and functional description
NPL 2: 3GPP TR 22.947, Technical Specification Group Services and System Aspects; Study on Personal Broadcast Service

### SUMMARY OF INVENTION

### Technical Problem

Efficiency based on base station device counting results according to the related art is restricted to a method for effectively employing resources of a radio communication section between the base station device and a terminal, and there has been no method for effectively employing resources of a communication section within a network between a multicast data distribution source device and the base station device.

Specifically, even when the base station device detects that there is no terminal to receive multicast data, multicast data is distributed from a multicast data distribution source device installed within the network to the base station device. Heretofore, there has been no solution to effectively employ network resources by reducing traffic using the counting function.

In this manner, though effective use of radio resources between the base station device and a terminal using the counting function has been taken into consideration, there is a problem in that network resources within a network are not available.

With the above NPL 1, procedures for releasing MBMS registration to a certain service have been described, but as a method thereof, there have been described procedures for a base station device taking the initiative to cancel MBMS registration as to a multicast data and broadcast data distribution source device.

However, with the base station device, nothing has been described regarding specific means to determine start of the MBMS deregistration procedure. Further, even at each device positioned on the upstream of a data distribution route, nothing has been described regarding specific means to determine start of the MBMS deregistration procedure as to a further upstream data distribution source device.

Further, when taking user convenience into consideration, the MBMS registration procedure or MBMS deregistration procedure has to be performed in response to regarding whether or not there is a user viewing and listening, but these have not been effectively performed heretofore.

Specifically, with a multicast mode, a deactivation procedure for requesting secession from a service by a user is performed, and the MBMS deregistration procedure is started upon completion thereof. Further, activation for service participation at the time of resuming distribution has to be performed. Therefore, in the event that the power of a mobile station device temporarily turns off, or in the event that a mobile station device is temporarily disconnected from a base station device which provides an MBMS service, an activation procedure has to be performed.

As described above, communication resources are ineffectively used, such as a control message for a deactivation procedure or the like having to be transmitted/received regarding MBMS deregistration. Also, an MBMS deregistration procedure does not originally need processing to be performed by the mobile station device, but a deactivation procedure needs a control message to be transmitted/received by the mobile station device, that is, needs a complicated procedure where MBMS deregistration that does not need processing to be performed by the mobile station device cannot be performed, which is inefficient.

Thus, in the event that the base station device has detected that there is no data reception terminal based on a counting result, or in the event that the base station device has detected that the mobile station device (terminal) has moved to a different base station device without performing resource release request, or the power of the mobile station device has been turned off, or the like, effective MBMS deregistration accompanying processing to be performed by the mobile station device cannot be performed. Consequently, regardless of network resources being actually used, traffic flows while the network resources are assigned, and the network resources are used wastefully.

Also, as a method to temporarily stop distribution in order to effectively use network resources, there can be conceived a method for performing a session stop procedure according to the related art. However, with the method according to the related art, only a procedure to stop a session from a distribution source to a distribution destination is specified, and session stop cannot be requested from a distribution destination to a distribution source. That is to say, session stop cannot be requested from a base station device to a distribution source.

Also, even if the procedure is expanded so as to request session stop from a base station device to a distribution source, a new problem occurs. A device which has received a session stop request can stop distribution and temporarily release the resources, but deletion of a distribution list is not performed. Accordingly, for example, heretofore, 1) in a state in which a session has been started, 2) in an event that a session alone has been stopped under the initiative of the base station device, 3) after all of sessions have been stopped under the initiative of the distribution source of multicast data (broadcast data), 4) in the event that all of sessions have been resumed under the initiative of the distribution source of multicast data (broadcast data), communication resources have been allocated to all of nodes (e.g., GGSN, SGSN, base station device) included in a distribution list, and consequently, even a session stopped under the initiative of the base station device has also been resumed. That is to say, though unnecessary resources have been released in 1), unnecessary resources will be allocated again.

Accordingly, in order to effectively utilize communication resources, updating of the distribution list is performed by the MBMS deregistration procedure, and in the event that a session has been resumed under the initiative of the distribution source of multicast data (broadcast data) as with 4), distribution to an unnecessary device has to be prevented from being resumed. This is necessary not only for efficiency of resources for data distribution, but also for eliminating the use of a control procedure as to an unnecessary device.

In order to solve the above problems, it is an object of the present invention to provide a mobile communication system or the like capable of effectively utilizing network resources by determining a control method to effectively allocate network resources using the counting function of a base station device.

### Solution to Problem

In order to solve the above problems, a mobile communication system or the like according to the present invention has the following features.

A mobile communication system according to the present invention configured to perform multicast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established, with the SGSN having registered the base station device in the MBMS; with information of an MBMS bearer which allocates and establishes MBMS bearer resources being included in an MBMS bearer context in the MBMS bearer service; and with the base station device transmitting a confirmation message including a service identifier to the mobile station device, counting the number of mobile station devices needing multicast data distribution, based on a response from the mobile station device, and in the event the counted number is 0, transmitting an MBMS deregistration request for the multicast data to the SGSN.

Also, with the mobile communication system according to the present invention, the service identifier includes a TMGI (Temporary Mobile Group Identity).

Also, with the mobile communication system according to the present invention, the SGSN deletes, in the event of having received the MBMS deregistration request, a base station device which has transmitted the MBMS deregistration request from a distribution list of the MBMS bearer context.

Also, with the mobile communication system according to the present invention, the base station device releases MBMS bearer resources along with transmission of the MBMS deregistration request to the SGSN.

Also, with the mobile communication system according to the present invention, the SGSN transmits, in the event that the base station device included in the distribution list of the MBMS bearer context becomes unavailable, an MBMS deregistration request correlated with the MBMS bearer context to the GGSN; with the GGSN deleting the SGSN which has transmitted the MBMS deregistration request from a distribution list within the MBMS bear context.

Also, with the mobile communication system according to the present invention, the GGSN transmits, in the event that the base station device which performs multicast data distribution, included in the distribution list of the MBMS bearer context becomes unavailable, an MBMS deregistration request correlated with the MBMS bearer context to the BM-SC; with the BM-SC deleting the GGSN which has transmitted the MBMS deregistration request from a distribution list within the MBMS bearer context.

A mobile communication system according to the present invention configured to perform broadcast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established, with the SGSN having registered the base station device in the MBMS; with information of an MBMS bearer which allocates and establishes MBMS bearer resources being included in an MBMS bearer context in the MBMS bearer service; and with the base station device transmitting a confirmation message including a service identifier to the mobile station device, counting the number of mobile station devices needing broadcast data distribution, based on a response from the mobile station device, and in the event that the counted number is 0, transmitting an MBMS deregistration request for the broadcast data to the SGSN.

Also, with the mobile communication system according to the present invention, the service identifier includes a TMGI (Temporary Mobile Group Identity).

Also, with the mobile communication system according to the present invention, the SGSN deletes, in the event of having received the MBMS deregistration request, the base station device which has transmitted the MBMS deregistration request from a distribution list of the MBMS bearer context.

Also, with the mobile communication system according to the present invention, the base station device transmits a session stop request along with transmission of the MBMS deregistration request to the SGSN.

Also, with the mobile communication system according to the present invention, the SGSN transmits, in the event that the base station device which perform broadcast data distribution, included in the distribution list of the MBMS bearer context becomes unavailable, an MBMS deregistration request correlated with the MBMS bearer context, to the GGSN; with the GGSN deleting the SGSN which has transmitted the MBMS deregistration request from a distribution list within the MBMS bear context.

Also, with the mobile communication system according to the present invention, the GGSN transmits, in the event that there is no more SGSN which performs broadcast data distribution included in the distribution list of the MBMS bearer context, an MBMS deregistration request correlated with the MBMS bearer context to the BM-SC; with a BM-SC deleting the GGSN which has transmitted the MBMS deregistration request from a distribution list within the MBMS bearer context.

A base station device according to the present invention to be connected to a mobile communication system configured to perform multicast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established, with information of an MBMS bearer which allocates and establishes MBMS bearer resources being included in an MBMS bearer context in the MBMS bearer service; and with the base station device transmitting to the SGSN an MBMS deregistration request for multicast data to be transmitted in the event that there is no mobile station device needing multicast data distribution.

A base station device according to the present invention to be connected to a mobile communication system configured to perform broadcast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established, with information of an MBMS bearer which allocates and establishes MBMS bearer resources being included in an MBMS bearer context in the MBMS bearer service; and with the base station device transmitting a confirmation message including a service identifier to the mobile station device, counting the number of mobile station devices needing broadcast data distribution, based on a response from the mobile station device, and in the event that the counted number is 0, transmitting an MBMS deregistration request for the broadcast data to the SGSN.

An SGSN according to the present invention to be connected to a mobile communication system configured to perform multicast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established, with the base station device having been registered in the MBMS; with information of an MBMS bearer which allocates and establishes MBMS bearer resources being included in an MBMS bearer context in the MBMS bearer service; with an MBMS deregistration request for multicast data to be transmitted in the event there is no mobile station device multicast data distribution being received from the base station device; and with the base station device which has transmitted the MBMS deregistration request being deleted from a distribution list of the MBMS bearer context in the event of having received the MBMS deregistration request.

An SGSN according to the present invention to be connected to a mobile communication system configured to perform broadcast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established, with the base station device having been registered in the MBMS; with information of an MBMS bearer which allocates and establishes MBMS bearer resources being included in an MBMS bearer context in the MBMS bearer service; with an MBMS deregistration request for broadcast data to be transmitted in the event there is no mobile station device needing broadcast data distribution being received from the base station device; and with the base station device which has transmitted the MBMS deregistration request being deleted from a distribution list of the MBMS bearer context in the event of having received the MBMS deregistration request.

A mobile station device according to the present invention to be connected to a mobile communication system to which the above present invention has been applied.

### Advantageous Effects of Invention

According to the present invention, with a mobile communication system configured to perform multicast data distribution from a BM-SC to a mobile station device (UE) to be connected to a base station device (NB) via a GGSN and an SGSN where an MBMS bearer has been established, in the event of detecting that the number of UE receiving multicast data is 0 using a counting function, and determining to perform MBMS deregistration of multicast data distribution, the base station device transmits an MBMS deregistration request to the SGSN, deletes a distribution destination device (NB) in a distribution list of multicast data, and also simultaneously performs release of resources that has heretofore been performed by session stop, and consequently, distribution form the SGSN is stopped.

Thus, heretofore, an MBMS deregistration procedure has been stipulated under the initiative of the base station device, but neither an MBMS registration procedure nor an MBMS deregistration procedure cannot be performed in response to whether or not there is a user viewing and listening. However, the base station device can delete a distribution destination device in a distribution list according to the MBMS deregistration procedure based on a necessity determination result of reception of the mobile station device, and also simultaneously perform release of resources that has been performed at a session stop procedure.

Also, as with a multicast mode, in the event that a deactivation procedure for requesting secession from the service according to a user is performed, the MBMS deregistration procedure is started upon completion thereof, and even at the time of resuming distribution, an activation for participating in the service is required, but by detecting whether or not there is a user viewing using the counting function, service distribution can be stopped without performing a deactivation procedure, and also, even at the time of resuming service distribution in such a case, the service can be received without performing the activation procedure. Also, with the mobile station device, even in the event that the power is temporarily turned off, or in the event of being temporarily disconnected to a base station device which provides an MBMS service, the deactivation procedure does not have to be performed.

As described above, transmission/reception of a control message such as the deactivation procedure does not have to be performed for the MBMS deregistration, and accordingly, communication resources can effectively be used. Also, with regard to the deactivation procedure, the mobile station device does not have to perform transmission/reception of a control message, and can effectively perform MBMS deregistration under the initiative of the base station device without performing processing by the mobile station device.

Thus, in the event of detecting that there is no data reception terminal based on a counting result, or in the event of detecting that the mobile station device (terminal) have moved to a different base station device without performing request for resource release, or in the event that the power of the mobile station device has been turned off, or the like, the base station device can perform effective MBMS deregistration, which does not accompany processing by the mobile station device. Consequently, a situation can be avoided wherein regardless of no network resource being actually used, traffic flows while the network resources are allocated, and the resources are used wastefully.

Also, with a conventional technique, only a procedure to stop a session from a distribution source to a distribution destination has been stipulated, and session stop from a distribution destination to a distribution source has been unavailable. Further, even if the procedure is expanded so as to request session stop from a base station device to a distribution source, a device which has received a session stop request can stop distribution and temporarily release the resources, but deletion of a distribution list is not performed.

Accordingly, for example, heretofore, 1) in a state in which a session has been started, 2) in an event that a session alone has been stopped under the initiative of the NB, 3) after all of sessions have been stopped under the initiative of the BM-SC, 4) in the event that all of sessions have been resumed under the initiative of the BM-SC, communication resources have been allocated to all of nodes (GGSN, SGSN, NB) included in the distribution list, and consequently, even a session stopped under the initiative of the NB has also been resumed, which has been a problem.

However, updating of a distribution destination device has been performed from the distribution list by the MBMS deregistration procedure, and for example, in the event that a session has been resumed under the initiative of the BM-SC as with 4) as well, an unnecessary session is prevented from being started.

Also, a session is not unnecessarily started, and accordingly, exchange of control information necessary at the time of starting a session can be reduced, and communication resources can effectively be utilized without communication resources necessary for a session start procedure being ineffectively used.

### BRIEF DESCRIPTION OF DRAWINGS

FIG. 1 is a diagram illustrating an overview of a mobile communication system according to a first embodiment.

FIG. 2 is a diagram for describing a function configuration of a BM-SC according to the first embodiment.

FIG. 3 is a diagram illustrating an example of a data structure of an MBMS service DB in the BM-SC.

FIG. 4 is a diagram illustrating an example of a data structure of an MBMS bearer context in the BM-SC.

FIG. 5 is a diagram illustrating an example of a data structure of an MBMS UE bearer context in the BM-SC.

FIG. 6 is a diagram for describing a function configuration of a GGSN according to the first embodiment.

FIG. 7 is a diagram illustrating an example of a data structure of an MBMS bearer context in the GGSN.

FIG. 8 is a diagram illustrating an example of a data structure of an upstream control node DB in the GGSN.

FIG. 9 is a diagram illustrating an example of a data structure of an MBMS UE bearer context in the GGSN.

FIG. 10 is a diagram for describing a function configuration of an SGSN according to the first embodiment.

FIG. 11 is a diagram illustrating an example of a data structure of an MBMS bearer context in the SGSN.

FIG. 12 is a diagram illustrating an example of a data structure of an MBMS UE bearer context in the SGSN.

FIG. 13 is a diagram for describing a function configuration of an NB according to the first embodiment.

FIG. 14 is a diagram illustrating an example of a data structure of an MBMS bearer context in the NB.

FIG. 15 is a diagram illustrating an example of a data structure of wireless frame information in the NB.

FIG. 16 is a diagram illustrating an example of a data structure of an MBMS UE bearer context in the NB.

FIG. 17 is a diagram for describing a flow of processing according to the first embodiment.

FIG. 18 is a diagram for describing a flow of processing according to the first embodiment.

FIG. 19 is a diagram for describing change in a bearer context according to the first embodiment.

FIG. 20 is a diagram for describing a flow of processing according to the first embodiment.

FIG. 21 is a diagram for describing a flow of processing according to the first embodiment.

FIG. 22 is a diagram for describing operation according to the first embodiment.

FIG. 23 is a diagram for describing a flow of processing according to a second embodiment.

FIG. 24 is a diagram for describing change in a bearer context according to the first embodiment.

FIG. 25 is a diagram for describing a flow of processing according to the second embodiment.

FIG. 26 is a diagram for describing a flow of processing according to the second embodiment.

### DESCRIPTION OF EMBODIMENTS

Hereinafter, optimal modes for implementing the present invention will be described with reference to the drawings.

### 1. First Embodiment

[1.1 System Configuration]

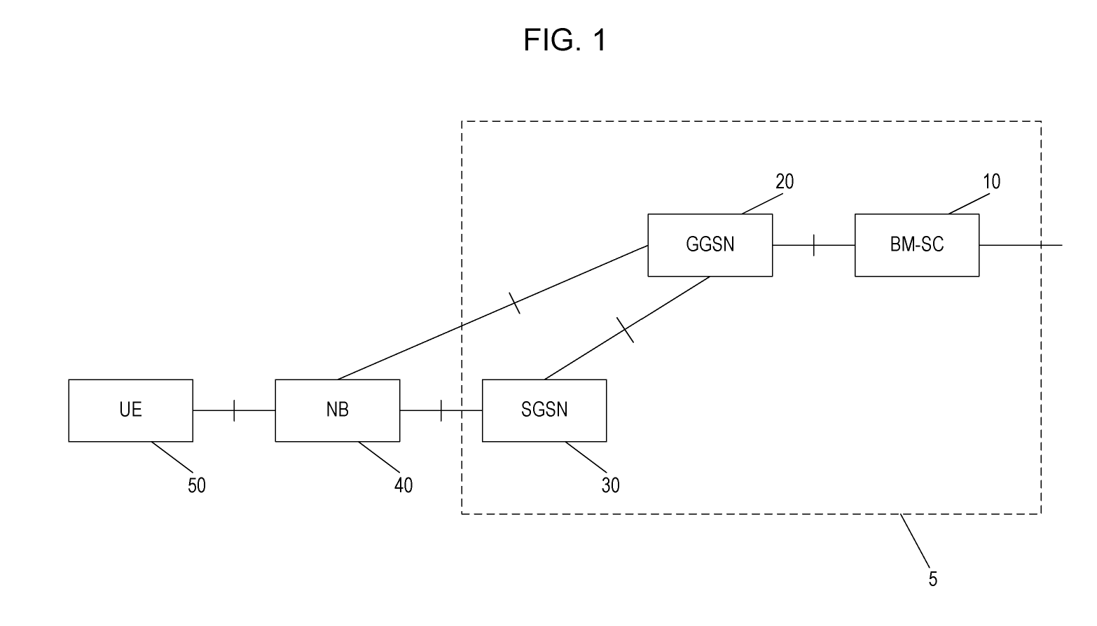

FIG. 1 is a diagram for describing overview of a mobile communication system 1 in the event of applying the present invention. The mobile communication system 1 is configured so as to include a BM-SC (Broadcast-Multicast Service Center) 10 which is a broadcast/multicast service center, a core network 5 including a GGSN (Gateway GPRS Support Node) 20 which is a gateway device, and an SGSN (Serving GPRS Support Node) 30 which is a service control device, an NB 40 which is a base station device, and a UE 50 which is a mobile station device.

The NB 40 is connected to the core network 5, and is configured so as to be connected to the UE 50. Specifically, the GGSN 20 is connected to a lower-level of the BM-SC 10, and the NB 40 is directly connected to a lower-level of the GGSN 20 via the SGSN 30. Further, the UE 50 is connected to a lower-level of the NB 40.

Now, in FIG. 1 according to the present embodiment, for convenience of description, each component device is described as a single device, but may be connected with multiple devices. For example, the mobile communication system 1 includes one or multiple GGSNs, and one or multiple SGSNs and NBs are connected to a lower level of each of the GGSNs. Also, a single or plurality of UE can also be connected to an NB.

[1.2 Device Configuration]

Next, the function configuration of each device will be described with reference to the drawings.

[1.2.1 BM-SC]

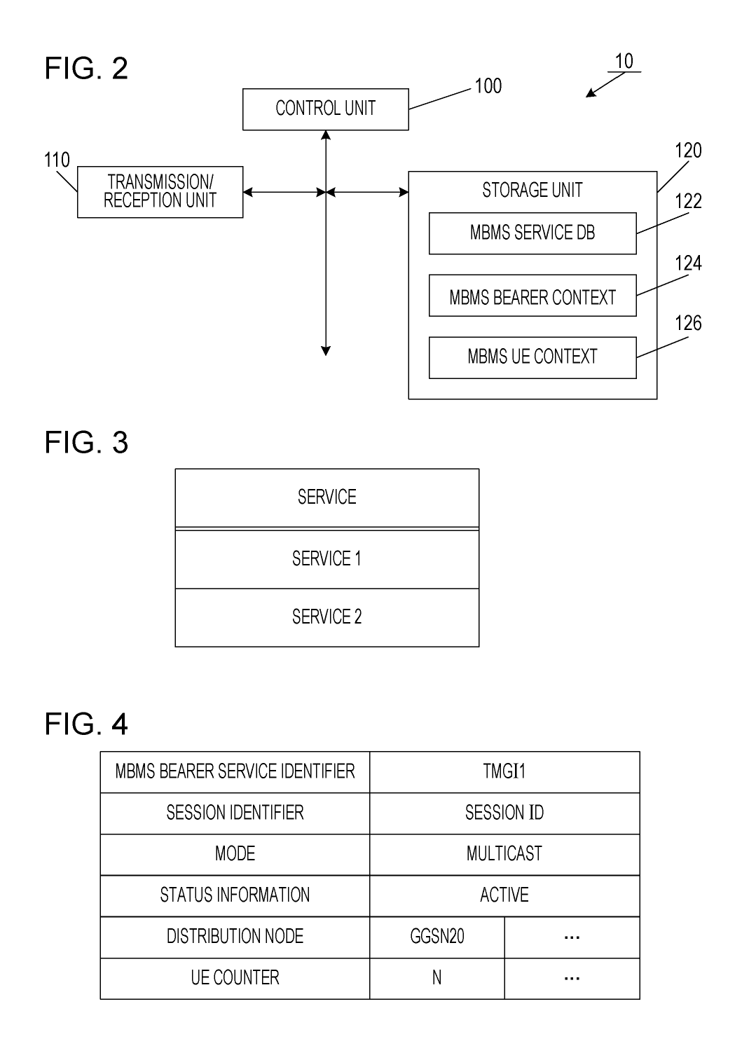

The function configuration of the BM-SC 10 will be described with reference to FIG. 2. With the BM-SC 10, a transmission/reception unit 110 and a storage unit 120 are connected to a control unit 100.

The control unit 100 is a function unit for controlling the entirety of the BM-SC 10. The control unit 100 realizes various functions by reading out various programs stored in the storage unit 120 to execute these, and is configured of a CPU (Central Process Unit) for example.

The transmission/reception unit 110 is an interface unit to be connected to the network, and is to be connected to the GGSN 20 via the network for example.

The storage unit 120 is a function unit in which various programs and various types of data necessary for operation of the BM-SC 10 are stored. The storage unit 120 is configured of semiconductor memory or HDD (Hard Disk Drive) or the like, for example. Also, with the present embodiment, an MBMS service DB 122, an MBMS bearer context 124, and an MBMS UE context 126 are each stored.

The MBMS service DB 122 is, in order to manage a distributable MBMS bearer service, a DB for storing a service identifier of distribution data for each MBMS bearer service. FIG. 3 illustrates an example of the data configuration of the MBMS service DB 122.

Now, though various identifiers are employed as “service identifier”, for example,

(1) TMGI (Temporary Mobile Group Identity) for identifying an MBMS bearer context,

(2) Other identifiers (e.g., an identifier to be allocated by a provider who provides service by operating the BM-SC 10),

and so forth are available.

With the present embodiment, description will be made assuming that the TMGI in (1) is employed. Specifically, at the time of multicast data distribution in the MBMS bearer service, a TMGI to identify the MBMS bearer context 124 to be generated for each service is employed. Here, the TMGI is heretofore temporarily allocated subscriber identification information to be used for a cellar phone service, but with the MBMS, is employed as information to identify a MBMS bearer service.

The MBMS bearer context 124 is generated for each MBMS bearer service, and is management information of an MBMS bearer to be established for distributing multicast data. FIG. 4 illustrates an example of the data structure of the MBMS bearer context 124.

The MBMS bearer context 124 includes an MBMS bearer service identifier such as the TMGI or the like necessary at the time of MBMS registration (e.g., “TMGI1”), an identifier of a session to be established for distribution (e.g., “session ID”), a mode for identifying whether the current mode is a multicast mode or broadcast mode (e.g., “multicast”), status information for managing whether the state of an MBMS bearer is active or suspended (e.g., “active”), the distribution node of a data distribution destination (e.g., “GGSN 20”, and a UE counter (e.g., “N”).

Here, with the distribution node, information for determining a node to be distributed is stored, and an IP address (the IP address of the GGSN 20 in the case of FIG. 4) is stored, for example. Here, one or multiple distribution nodes can be stored.

The UE counter is the number of UE which receive multicast data in an MBMS bearer service. This is based on the number counted by the counting function of the base station device (NB 40), and may be, for example, the number of UEs 50 themselves connected to the NB 40, or may be number of UEs 50 participating in the multicast group, of all the UEs 50. This also may be the number of terminals (UE 50) which users are actually viewing and listening to, for example, i.e., a number obtained by detecting a state of viewpoint and listening applications not activated by the user or the like, and subtracting UEs 50 temporarily not viewing and listening, or the number of UEs 50 regarding which the user has made notification that reception is necessary.

Further, in the event that information of GGSNs which are multiple distribution nodes is stored in the MBMS bearer context 124, the BM-SC 10 can store a different UE counter for each GGSN, and count the number of UE. Accordingly, the BM-SC 10 can store the number of viewing terminals for multicast data to be distributed to the GGSN 20.

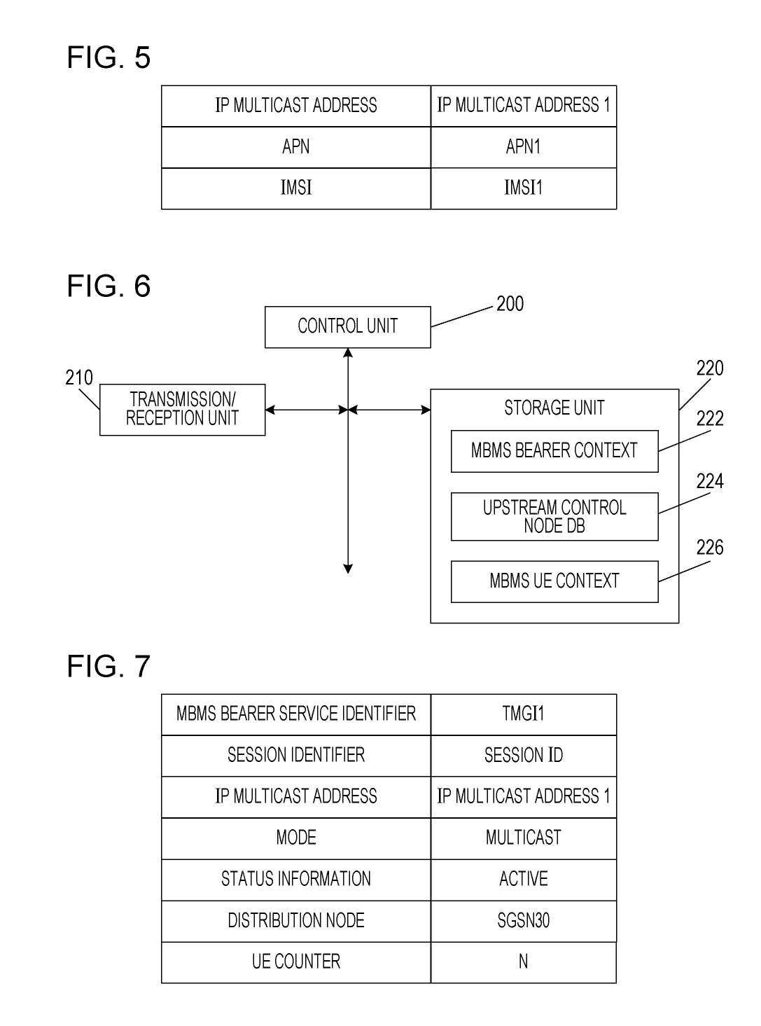

The MBMS UE context 126 is generated for each MBMS service, and is management information of UE which indicates participation in an MBMS service. The BM-SC 10 can perform accounting for each MBMS service by performing user registration for each MBMS service with reference to the MBMS UE context 126. FIG. 5 illustrates an example of the data structure of the MBMS UE context 126.

The MBMS UE context 126 includes an IP multicast address necessary in the case of activating an MBMS service (e.g., “IP multicast address 1”), information of APN (Access Point Name) necessary in the case of obtaining an IP Address at the time of initial connection by the UE 50 (e.g., “APN 1”), and information of IMSI (International Mobile Subscriber Identity) to be used for identifying UE (e.g., “IMSI1”).

[1.2.2 GGSN]

Next, the function configuration of the GGSN 20 will be described with reference to FIG. 6. With the GGSN 20, a control unit 200 is connected to a transmission/reception unit 210 and a storage unit 220.

The control unit 200 is a function unit configured to control the entirety of the GGSN 20. The control unit 200 realizes various functions by reading out and executing various programs stored in the storage unit 220, and is configured of a CPU (Central Process Unit), for example.

The transmission/reception unit 210 is an interface unit to be connected to the network, and is connected to the BM-SC 10, SGSN 30, and NB 40 via the network, for example.

The storage unit 220 is a function unit in which various programs and various data necessary for the operation of the GGSN 20 are stored. The storage unit 220 is configured of semiconductor memory or HDD (Hard Disk Drive) or the like, for example. Also, with the present embodiment, an MBMS bearer context 222, an upstream control node DB 224, and an MBMS UE context 226 are each stored. Here, the MBMS bearer context 222 can uniquely be identified by TMGI.

The MBMS bearer context 222 is generated for each MBMS bearer service, and is management information necessary for distributing multicast data. FIG. 7 illustrates an example of the data structure of the MBMS bearer context 222.

The MBMS bearer context 222 includes an MBMS bearer service identifier such as TMGI or the like (e.g., “TMGI1”), an identifier of a session to be established for distribution (e.g., “session ID”), an IP multicast address for performing IP multicast communication (e.g., “IP multicast address 1”), a mode for identifying whether the current mode is the multicast mode or broadcast mode (e.g., “multicast”), status information for managing whether the state of an MBMS bearer is active or suspended (e.g., “active”), the distribution node of a data distribution destination (e.g., “SGSN 30”), and a UE counter (e.g., “N”).

Now, the distribution node stores information for determining a node to be distributed, and stores an IP address (the IP address of the SGSN 30 in the case of FIG. 7), for example. Also, multiple distribution nodes may be stored.

The IP multicast address is stored for each MBMS bearer service corresponding to the MBMS bearer context 222.

The UE counter is the number of mobile station devices (terminals) which receive multicast data of an MBMS bearer service. This is based on the number counted by the counting function of the base station device (NB 40), and is the number of mobile station devices (terminals) which users are actually viewing and listening to, or the like.

Further, in the event that information of SGSNs which are multiple distribution nodes is stored in the MBMS bearer context 222, the GGSN 20 can store a different UE counter for each SGSN, and count the number of UE. Accordingly, the GGSN 20 can store the number of viewing terminals of multicast data to be distributed to the SGSN 30.

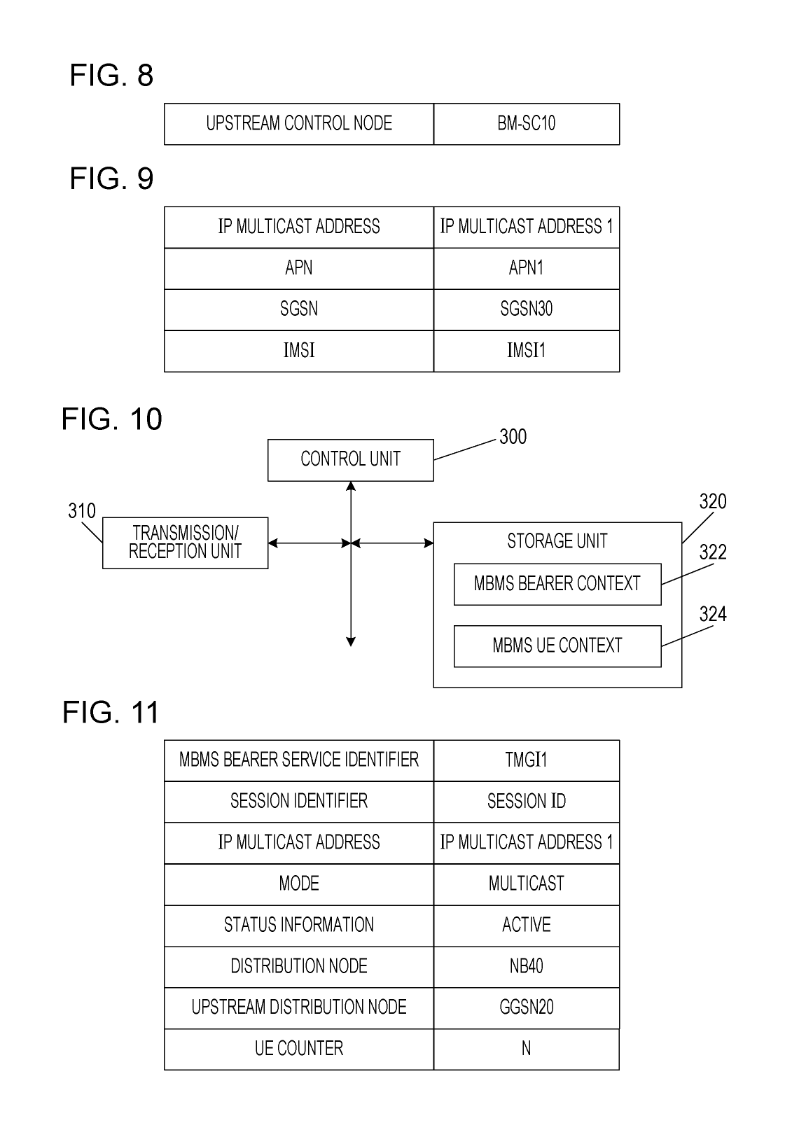

The upstream control node DB 224 is a DB for storing information for determining an upstream multicast data distribution device. FIG. 8 illustrates an example of the configuration of the upstream control node DB 224. With the present embodiment, information regarding the BM-SC 10 is stored, and the IP address of the BM-SC 10 is stored, for example.

The upstream control node DB 224 stores, as illustrated in FIG. 8, one upstream control node (BM-SC 10). Alternatively, the upstream control node DB 224 may store multiple upstream control nodes (BM-SC) for each service. In this case, the upstream control node DB 224 stores multiple upstream control nodes for each MBMS bearer context 222 which can be identified by TMGI or the like.

The MBMS UE context 226 is generated for each MBMS service, and is management information of the UE 50 which indicates that the UE 50 participates in an MBMS service. In the event that the first MBMS UE context 226 has been generated in a certain MBMS service, the GGSN 20 performs MBMS registration. Also, in the event that the last MBMS UE context 226 has been deleted in a certain MBMS service, the GGSN 20 performs MBMS deregistration. FIG. 9 illustrates an example of the data structure of the MBMS UE context 226.

The MBMS UE context 226 includes an IP multicast address necessary in the case of activating an MBMS service (e.g., “IP multicast address 1”), information of APN necessary in the event of the UE 50 obtaining an IP address at the time of initial connection (e.g., “APN1”), an SGSN to be passed through at the time of service distribution (e.g., “SGSN 30”), and information of IMSI to be used for identifying UE (e.g., “IMSI1”).

[1.2.3 SGSN]

Next, the function configuration of the SGSN 30 will be described with reference to FIG. 10. With the GGSN 30, a control unit 300 is connected to a transmission/reception unit 310 and a storage unit 320.

The control unit 300 is a function unit configured to control the entirety of the SGSN 30. The control unit 300 realizes various functions by reading out and executing various programs stored in the storage unit 320, and is configured of a CPU (Central Process Unit), for example.

The transmission/reception unit 310 is an interface unit to be connected to the network, and is connected to the GGSN 20, and NB 40 via the network, for example.

The storage unit 320 is a function unit in which various programs and various data necessary for the operation of the SGSN 30 are stored. The storage unit 320 is configured of semiconductor memory or HDD (Hard Disk Drive) or the like, for example. Also, with the present embodiment, an MBMS bearer context 322 and an MBMS UE context 324 are stored.

The MBMS bearer context 322 is generated for each MBMS bearer service, and is management information necessary for distributing multicast data. FIG. 11 illustrates an example of the data structure of the MBMS bearer context 322. Here, the MBMS bearer context 322 can uniquely be identified by TMGI.

The MBMS bearer context 322 includes an MBMS bearer service identifier such as TMGI or the like (e.g., “TMGI1”), an identifier of a session to be established for distribution (e.g., “session ID”), an IP multicast address for performing IP multicast communication (e.g., “IP multicast address 1”), a mode for identifying whether the current mode is the multicast mode or broadcast mode (e.g., “multicast”), status information for managing whether the state of an MBMS bearer is active or suspended (e.g., “active”), the distribution node of a data distribution destination (e.g., “NB 40”), a higher-level distribution node serving as a higher-level distribution node (e.g., “GGSN 20”), and a UE counter (e.g., “N”).

Now, the distribution node and higher-level distribution node store information for determining each node, and store an IP address (the IP addresses of the NB 40 and GGSN 20 in the case of FIG. 11), for example. Also, multiple distribution nodes may be stored.

The IP multicast address is stored for each MBMS bearer service corresponding to the MBMS bearer context 322.

The UE counter is the number of mobile station devices (terminals) which receive multicast data of an MBMS bearer service. This is based on the number counted by the counting function of the base station device (NB 40), and is the number of mobile station devices (UE) which users are actually viewing and listening to, or the like.

Further, in the event that information of NBs which are multiple distribution nodes is stored in the MBMS bearer context 322, the SGSN 30 can store a different UE counter for each NB, and count the number of UE. Accordingly, the SGSN 30 can store the number of viewing terminals of multicast data to be distributed to the NB 40.

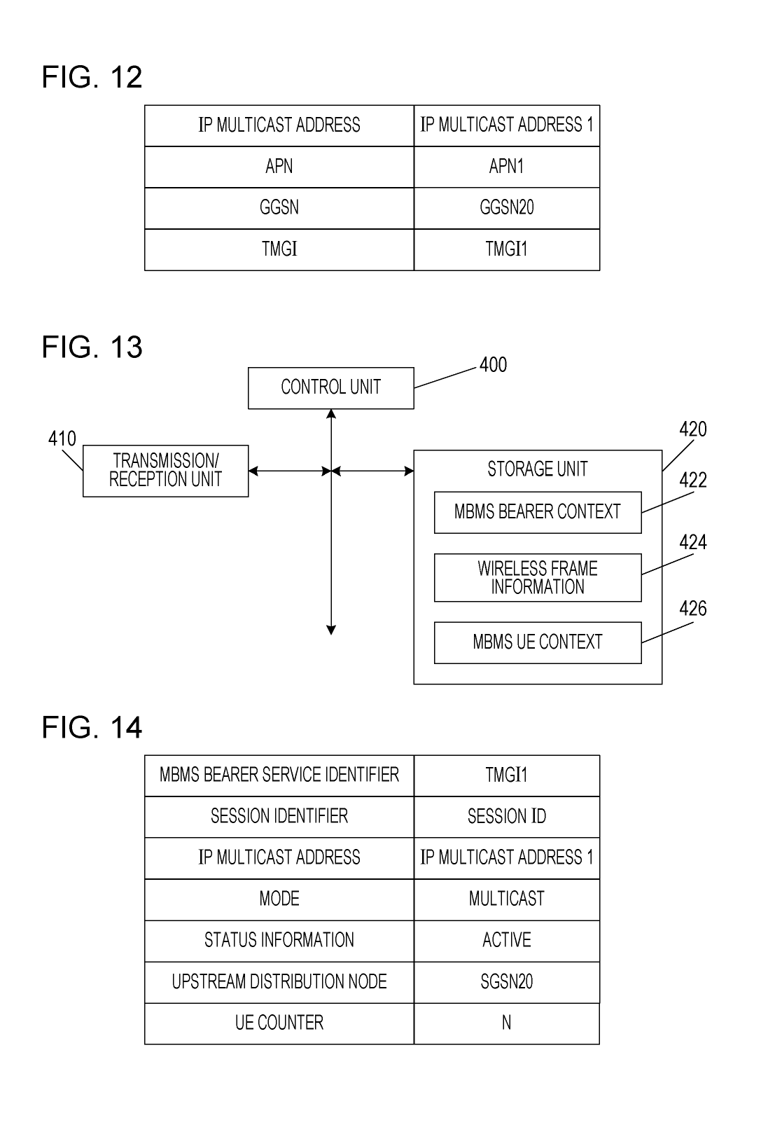

The MBMS UE context 324 is generated for each MBMS service, and is management information of the UE 50 in multicast data distribution. In the event that the first MBMS UE context 324 has been generated in a certain MBMS service, the SGSN 30 performs MBMS registration. Also, in the event that the last MBMS UE context 324 has been generated in a certain MBMS service, the SGSN 30 performs MBMS deregistration. FIG. 12 illustrates an example of the data structure of the MBMS UE context 324.

The MBMS UE context 324 includes an IP multicast address necessary in the case of activating an MBMS service (e.g., “IP multicast address 1”), information of APN necessary in the event of the UE 50 obtaining an IP address at the time of initial connection (e.g., “APN1”), a GGSN to be passed through at the time of service distribution (e.g., “GGSN 20”), and TMGI that indicates a multicast service in which the UE 50 participates (e.g., “TMGI1”).

[1.2.4 NB]

Next, the function configuration of the NB 40 will be described with reference to FIG. 13. With the NB 40, a control unit 400 is connected to a transmission/reception unit 410 and a storage unit 420.

The control unit 400 is a function unit configured to control the entirety of the NB 40. The control unit 400 realizes various functions by reading out and executing various programs stored in the storage unit 420, and is configured of a CPU (Central Process Unit), for example.

The transmission/reception unit 410 is an interface unit to be connected to the network, and is connected to the GGSN 20 and SGSN 30 via the network, for example, and further a UE 50 can be connected.

The storage unit 420 is a function unit in which various programs and various data necessary for the operation of the NB 40 are stored. The storage unit 420 is configured of semiconductor memory or HDD (Hard Disk Drive) or the like, for example. Also, with the present embodiment, an MBMS bearer context 422, radio frame information 424, and an MBMS UE context 426 are each stored. Here, the MBMS bearer context 422 can uniquely be identified by TMGI.

The MBMS bearer context 422 is generated for each MSMS bearer service, and is management information necessary for distributing multicast data. FIG. 14 illustrates an example of the data structure of the MBMS bearer context 422.

The MBMS bearer context 422 includes an MBMS bearer service identifier such as TMGI or the like (e.g., “TMGI1”), an identifier of a session to be established for distribution (e.g., “session ID”), an IP multicast address for performing IP multicast communication (e.g., “IP multicast address 1”), a mode for identifying whether the current mode is the multicast mode or broadcast mode (e.g., “multicast”), status information for managing whether the state of an MBMS bearer is active or suspended (e.g., “active”), information of an higher-level distribution node serving as a higher-level distribution node (e.g., “SGSN 30”), and a UE counter (e.g., “N”).

Now, as information of the higher-level distribution node, information for determining a node is stored, and an IP address (IP address of SGSN 30 in the case of FIG. 14) is stored, for example.

The IP multicast address is stored for each MBMS bearer service corresponding to the MBMS bearer context 422.

The UE counter is the number of mobile station devices (terminals) which receive multicast data of an MBMS bearer service. This is based on the number counted by the counting function of the base station device (NB 40), and is the number of mobile station devices (UE 50) which the user actually views and listens to, or the like.

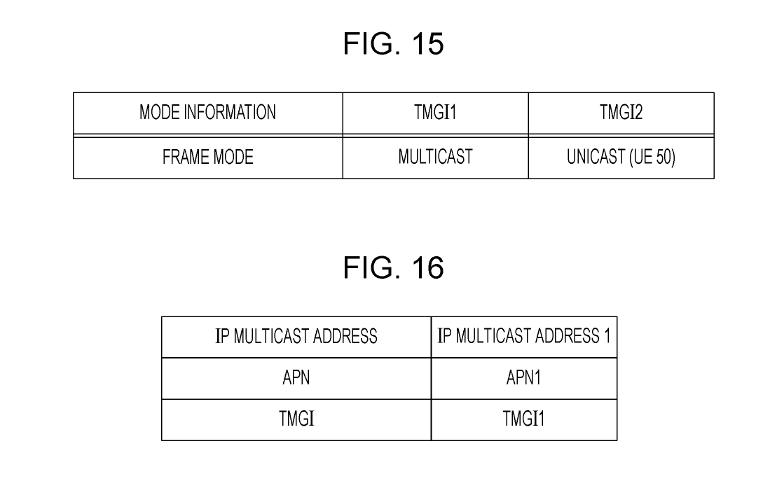

The radio frame information 424 stores information of radio frames to be transmitted to the UE 50 from the NB 40 via a radio section, for each MBMS bearer service. FIG. 15 illustrates an example of the data structure of the radio frame information 424.

Specifically, the radio frame information 424 stores mode information that indicates whether the current mode is the multicast mode or unicast mode (e.g., “frame mode”) for each identifier for identifying an MBMS bearer service (e.g., for each TMGI). Further, in the event of the unicast mode, the radio frame information 424 stores identification information such as the IMSI (International Mobile Subscriber Identity) of the UE 50 which performs frame distribution, or the like. A plurality of UE (identification information) which performs frame distribution may be stored.

The MBMS UE context 426 is generated for each MBMS bearer service, and is management information of the UE 50 in multicast data distribution. In the event that the first MBMS UE context has been generated in a certain MBMS service, the NB 40 performs MBMS registration. Also, in the event that the last MBMS UE context has been generated in a certain MBMS service, the NB 40 performs MBMS deregistration. FIG. 16 illustrates an example of the data structure of the MBMS UE context 426.

Specifically, the MBMS UE context 426 includes an IP multicast address necessary at the time of activating an MBMS service (e.g., IP multicast address 1), APN necessary for the UE obtaining an IP address at the time of initial connection (e.g., “APN1”), and TMGI that indicates a multicast service in which the UE 50 participates (e.g., “TMGI1”).

[1.3 Procedure Processing]

Next, procedure processing of the mobile communication system 1 according to the present embodiment will be described with reference to the drawing.

[1.3.1 Service Announcement Procedure]

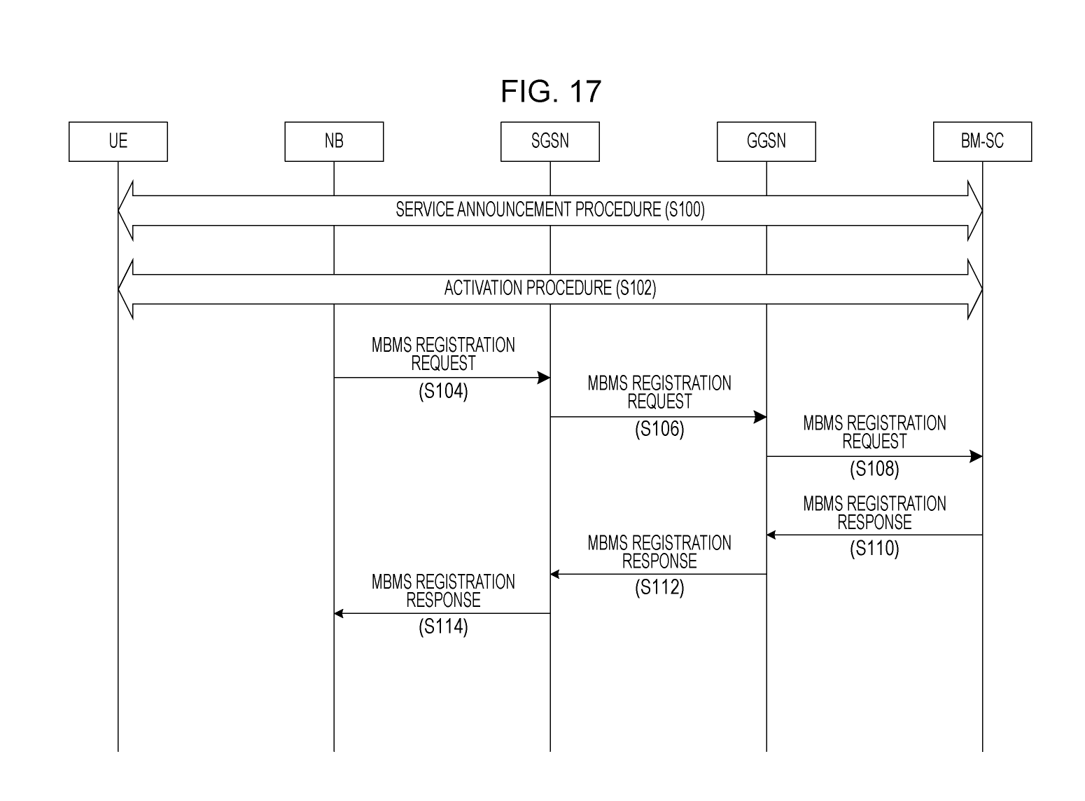

First, as illustrated in FIG. 17, the BM-SC 10 first performs a service announcement procedure on the UE 50 (S100). That is to say, the BM-SC 10 informs a distributable service to the UE 50. Thus, the UE 50 detects a multicast service.

The BM-SC 10 informs the UE 50 that distribution of a service managed at the MBMS service DB 122 is available by informing a service identifier. Further, a service identifier may be informed by adding information for describing a service, such as a program title, a content title, distribution start time, and so forth, thereto.

Now, various identifiers are employed as a service identifier, but for example,

(1) TMGI,

(2) Other identifiers (e.g., other identifiers whereby an MBMS bearer service set by a provider can be identified), and so forth are available. With the present embodiment, description will be made assuming that TMGI in (1) is employed.

Also, as a specific informing method, various methods can be conceived, but for example, an SMS (Short Message Service) or the like is employed to inform a distributable service to a distributable UE 50 registered beforehand or to an unspecified number of UEs 50, or information is displayed on a website to obtain the information by the UE 50 accessing a web server.

[1.3.2 Activation Procedure]

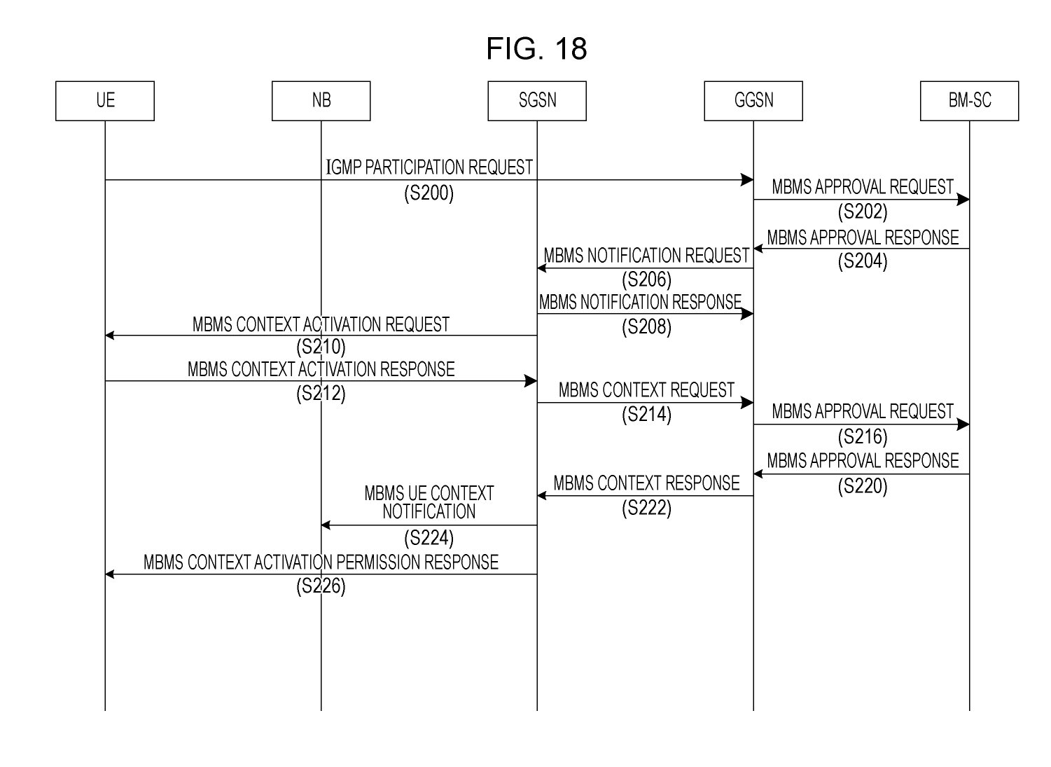

Next, the UE 50 performs an activation procedure for participating in a multicast service informed by a service announcement (S102). Now, the activation procedure for the UE 50 participating in a multicast service will be described with reference to FIG. 18.

The present activation procedure is started by the UE 50 performing IGMP participation request to the GGSN 20 (S200). Now, there are various methods for requesting the GGSN 20 so that the UE 50 participates in an MBMS service, but for example, the UE 50 may inform the GGSN 20 of information that uniquely indicates a service informed by the service announcement. Specifically, in the event of performing communication using IPv4, IGMP Membership Report is transmitted, and in the event of performing communication using IPv6, MLD Membership Report is transmitted.

Next, the GGSN 20 transmits an MBMS approval request for the UE 50 serving as a participation requestor participating in a service to the BM-SC 10 (S202). The BM-SC 10 which has received the MBMS approval request approves the UE 50 serving as a participation requestor based on a service contract thereof. Now, accounting processing may be performed on the UE 50 to be approved.

Next, the BM-SC 10 transmits an approval response that indicates the UE 50 is approved to the GGSN 20 (S204). Here, the BM-SC 10 transmits APN by being included in the approval response. However, in the event that the BM-SC 10 does not permit the UE 50 participation in the service, transmission of an approval response may be omitted.

Next, the GGSN 20 transmits an MBMS information request to the SGSN 30 (S206). Here, the GGSN 20 transmits including an IP multicast address and APN and the MBMS information request. Also, the IP multicast address is an address where the UE 50 has performed participation request. Next, the SGSN 30 transmits an MBMS information response to the GGSN 20 (S208).

Further, the SGSN 30 transmits, in order to activate an MBMS UE context, an MBMS context activation request to the UE 50 (S210). Here, the SGSN 30 transmits an IP multicast address and APN by being included in the MBMS context request.

The UE 50 which has received the MBMS context activation request creates an MBMS UE context, and transmits an MBMS context activation response to the SGSN 30 (S212). Here, an IP multicast address, APN, and information relating to QoS that can be processed by the UE 50 are included in the MBMS context activation response. Also, an IP multicast address, APN, information of GGSN which is a higher-level distribution node, and information of TMGI are included in the MBMS UE context.

Next, the SGSN 30 which has received the MBMS UE context activation response from the UE 50 creates an MBMS UE context, and transmits an MBMS context request to the GGSN 20 (S214). Here, the SGSN 30 transmits an IP multicast address and APN by being included in the MBMS context request. Also, an IP multicast address, APN, and an SGSN which is a distribution node are included in the MBMS UE context.

Next, the GGSN 20 which has received the MBMS context request from the SGSN 30 transmits, in order to confirm service participation by the UE 50, an MBMS approval request to the BM-SC 10 (S216). The BM-SC 10 which has received the MBMS approval response from the GGSN 20 creates an MBMS UE context after confirming service participation by the UE 50. An IP multicast address and APN are included in the MBMS UE context. Next, the BM-SC 10 transmits an MBMS approval response to the GGSN 20 (S220).

The GGSN 20 which has received the MBMS approval response from the BM-SC 10 creates an MBMS UE context, and transmits the MBMS context response to the SGSN 30 (S222).

Next, the SGSN 30 transmits an MBMS UE context notification to the NB 40 (S224). The NB 40 which has received the MBMS UE context notification from the SGSN 30 creates an MBMS UE context. An IP multicast address, APN, and TMGI are included in the MBMS UE context.

Next, the SGSN 30 transmits an MBMS context activation permission response to the UE 50 (S226). The SGSN 30 transmits a TMGI by being included in the MBMS context activation permission response. Here, the TMGI is an identifier that uniquely indicates an MBMS service.

[1.3.3 MBMS Registration Procedure]

Next, an MBMS registration procedure in a certain MBMS service will be described returning to FIG. 17. According to the MBMS registration procedure, a communication path from the BM-SC 10 to the UE 50 is established.

In order to establish a communication path, it is necessary to generate the MBMS bearer context 124 at the BM-SC 10, the MBMS bearer context 222 at the GGSN 20, the MBMS bearer context 322 at the SGSN 30, and the MBMS bearer context 422 at the NB 40, and to register each distribution node list within the MBMS bearer context 124 at the BM-SC10, the MBMS bearer context 222 at the GGSN 20, the MBMS bearer context 322 at the SGSN 30, and the MBMS bearer context 422 at the NB 40.

The MBMS bearer context (identifiable by TMGI) is generated at each of the BM-SC 10, GGSN 20, and SGSN 30, and a downlink node is registered in each distribution list within the MBMS bearer context 124 at the BM-SC 10, the MBMS bearer context 222 at the GGSN 20, the MBMS bearer context 322 at the SGSN 30, and the MBMS bearer context 422 at the NB 40.

Specifically, the GGSN 20 is registered in the distribution list at the BM-SC 10, the SGSN 30 is registered in the distribution list at the GGSN 20, and the NB 40 is registered in the distribution list at the SGSN 30, respectively. Also, multiple downlink nodes may be registered in each distribution list at the BM-SC 10, GGSN 20, SGSN 30, and NB 40.

First, the NB 40 starts the MBMS registration procedure by detecting a UE 50 participating in an MBMS service. Here, there are various methods for the NB 40 detecting a UE 50 participating in an MBMS service, but for example, the UE 50 may inform the NB 40 of information that uniquely indicates a service informed by the service announcement.

Now, the NB 40 may generate an MBMS UE context corresponding to a service. An IP multicast address, APN, and TMGI are included in the MBMS UE context. Further, in the event of having generated the first MBMS UE context in which this TMGI is included, the NB 40 takes this as a signal for an MBMS registration start procedure.

Further, a trigger for the NB 40 starting the MBMS registration procedure may be performed at optional timing according to an operator's policy or the like, other than the above.

Next, the NB 40 transmits an MBMS registration request for MBMS registration of a service specified at the UE 50 to the SGSN 30 (S104). Here, the NB 40 transmits a TMGI, an IP multicast address, and APN, included in the MBMS registration request.

The SGSN 30 which has received the MBMS registration request from the NB 40 transmits an MBMS registration request to the GGSN 20 (S106). Here, a TMGI, an IP multicast address, and APN are included in the MBMS registration request.

Here, the SGSN 30 generates an MBMS bearer context 322 corresponding to a service. The SGSN 40 includes a TMGI for identifying a service in the MBMS bearer context 322. Further, the SGSN 30 sets the status information of bearer resources at the MBMS bearer context 322 to “standby”.

Now, the SGSN 30 may generate an MBMS UE context 324 of the UE 50 participating in the service. An IP multicast address, APN, TMGI, and information of the GGSN which is a higher-level distribution node are included in the MBMS UE context 324.

The GGSN 20 which has received the MBMS registration request from the SGSN 30 generates an MBMS bearer context 222, and transmits an MBMS registration request to the BM-SC 10 (S108). Here, the GGSN 20 sets the status information of bearer resources at the MBMS bearer context 222 to “standby”. Here, the GGSN 20 may generate an MBMS UE context 226 of the UE 50 participating in the service. An IP multicast address, APN, and information of the SGSN which is a distribution node are included in the MBMS UE context 226.

The BM-SC 10 which has received the MBMS registration request from the GGSN 20 registers in the distribution list the identifier of the GGSN 20 which has transmitted the MBMS registration request in the MBMS bearer context 124, and replies an MBMS registration response (S110). Here, information regarding TMGI and QoS is included in the MBMS registration response.

The GGSN 20 which has received the MBMS registration request from the SGSN 30 in S106 registers the identifier of the SGSN 30 which has transmitted the MBMS registration request in the distribution list of the MBMS bearer context 222, and replies an MBMS registration response (S112). Here, the TMGI and information regarding a bearer necessary for this MBMS service are included in the MBMS registration response.

The SGSN 30 which has received the MBMS registration request from the NB 40 in S104 registers the identifier of the NB 40 which has transmitted the MBMS registration request in the distribution list of the MBMS bearer context 322, and replies an MBMS registration response (S114).

According to the above service announcement procedure, activation procedure, and MBMS registration procedure, a distribution list is formed between the UE 50 and BM-SC 10, whereby a route for distributing multicast distribution data of a service which the BM-SC 10 has transmitted to the NB 40 can be generated.

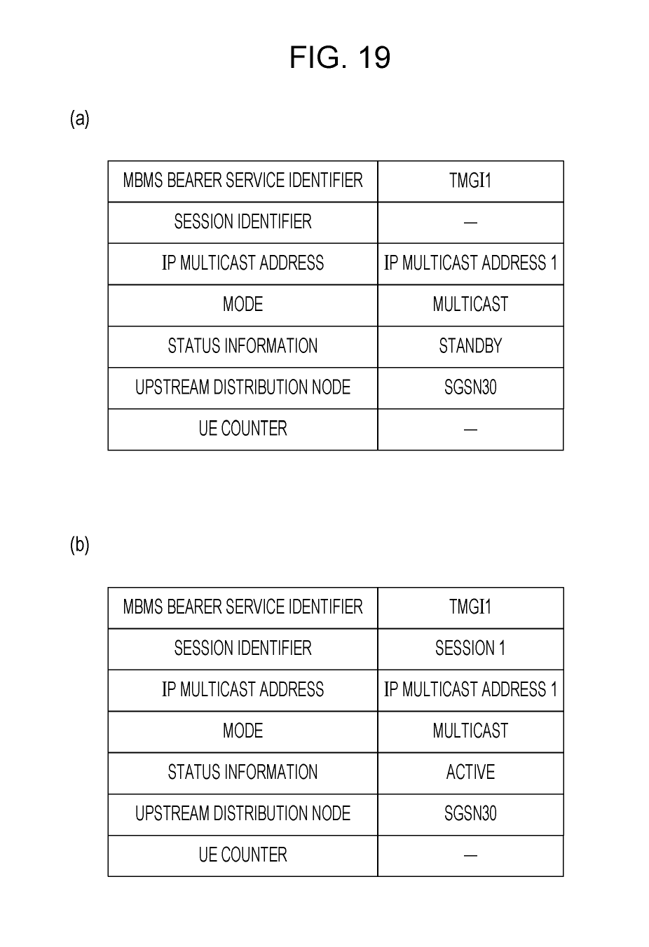

Note that a node to be registered in the distribution list does not follow the above description, and may be registered by an operator beforehand. Now, the MBMS bearer context 422 which the NB 40 stores after the MBMS registration procedure is illustrated in (a) in FIG. 19. As illustrated in (a) in FIG. 19, “TMGI1” is stored in the MBMS bearer service identifier, “IP multicast address 1” in the IP multicast address, “multicast” in the mode, “standby” in the status information, and “SGSN 30” in the higher-level distribution node, respectively.

Note that description has been made above regarding processing in the event that the SGSN 30 has received an MBMS deregistration request, but even in the event that another SGSN has received an MBMS deregistration request from the NB 40, the same procedure is performed as with the SGSN 30.

Similarly, with the GGSN 20 as well, though there has been described processing in the event that the GGSN 20 has received an MBMS registration request, even in the event that another GGSN has received an MBMS registration request from the SGSN, the same procedure is performed as with the GGSN 20.

Similarly, with the BM-SC 10 as well, though there has been described processing in the event that the BM-SC 10 has received an MBMS registration request, even in the event that another BM-SC has received an MBMS registration request from the GGSN, the same procedure is performed as with the BM-SC 10.

[1.3.4 Session Start Procedure]

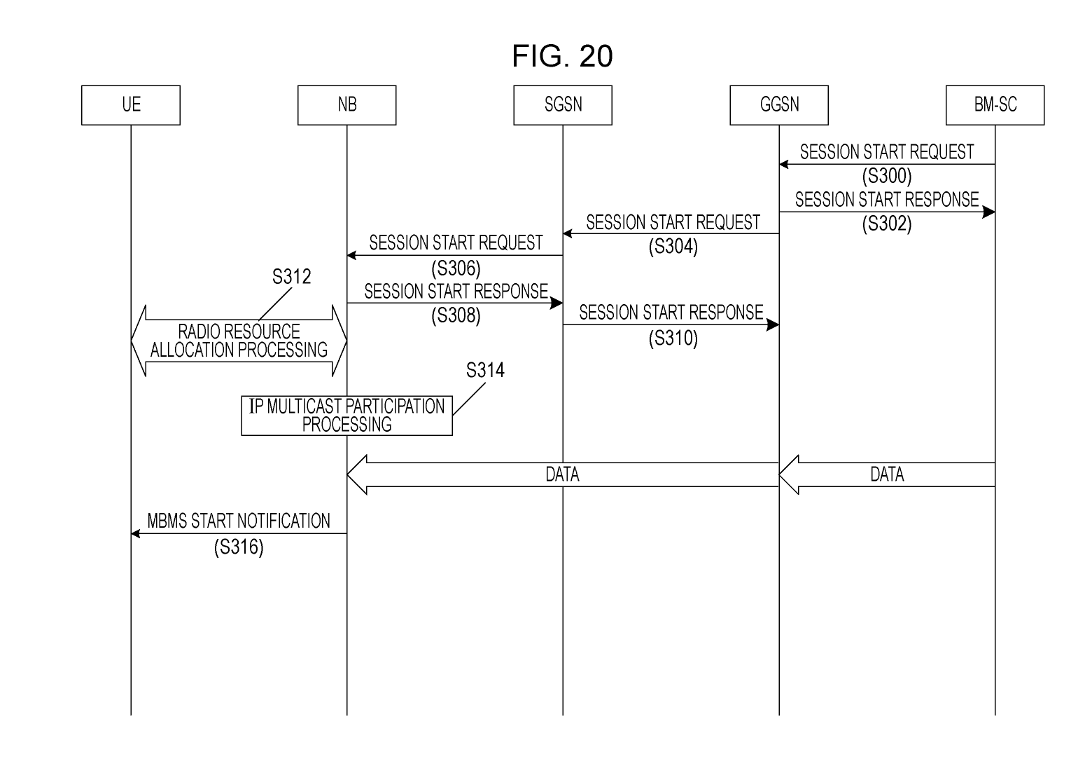

The session start procedure to be executed next will be described with reference to FIG. 20. According to the session start procedure, an MBMS bearer is established, and preparation for transmitting data is performed. First, the BM-SC 10 specifies a service, and transmits a session start request to the GGSN 20 (S300). Here, the BM-SC 10 generates a session identifier for identifying a session, and transmits the generated session identifier and TMGI for specifying a service by being included in the session start request. Thus, the session start procedure is started.

Also, with the corresponding MBMS bearer context 124 (identifiable by TMGI), the session identifier is registered, and the status information is registered as active.

Also, the BM-SC 10 transmits the session start request to all of the GGSNs 20 registered in the distribution node in the MBMS bearer context 124.

The GGSN 20 receives the session start request, and replies to this by transmitting a session start response to the BM-SC 10 (S302). Also, the GGSN 20 registers, with the corresponding MBMS bearer context 222, the session identifier and registers the status information as active. Information regarding the SGSN 30 is registered in the distribution list. Here, multiple SGSNs are registered in the distribution node.

Note that the SGSNs 30 which are distribution nodes to be registered may be the SGSN 30 registered beforehand by the operator, or may be the corresponding SGSN 30 selected based on an MBMS service area identifier included in the session start request transmitted from the BM-SC 10 with reference to the list of distribution nodes (SGSN 30 and so forth) for each MBMS service area registered through the MBMS registration procedure.

According to the above procedure, there is established an MBMS bearer which is a distribution route where communication quality for multicast data distribution between the BM-SC 10 and GGSN 20 is secured.

Further, in order to perform transmission by an MBMS bearer using IP multicast communication, an IP multicast address is allocated to the service and registered in the MBMS bearer context 222.

The GGSN 20 transmits a session start request to the SGSNs 30 registered in the distribution node in the MBMS bearer context 222 (S304). In order to specify a service, TMGI, a session identifier, and an IP multicast address are included in the session start request.

Also, the session start request is transmitted to all of the SGSNs registered in the distribution node in the MBMS bearer context 222.

The SGSN 30 receives the session start request, and replies to this by transmitting a session start response to the GGSN 20 (S310). Also, the SGSN 30 generates an MBMS bearer context 322, registers TMGI, session identifier, and IP multicast address, and registers the status information as active.

Information regarding the NB 40 is registered in the distribution node. Here, multiple NBs are registered in the distribution node.

According to the above procedure, there is established an MBMS bearer which is a distribution route where communication quality for multicast data distribution between the GGSN 20 and SGSN 30 is secured.

The SGSN 30 transmits a session start request to the NBs 40 registered in the distribution node in the MBMS bearer context 322 (S306). TMGI, session identifier, and IP multicast address are included in the session start request.

Also, the session start request is transmitted to all of the NBs registered in the distribution node in the MBMS bearer context 322.

The NB 40 receives the session start request, and replies to this by transmitting a session start response to the SGSN 30 (S308). Also, the NB 40 generates an MBMS bearer context 422, registers TMGI, session identifier, and IP multicast address, and registers the status information as active. Further, the NB 40 registers information regarding the SGSN 30 serving as a higher-level distribution node which has transmitted the request.

According to the above procedure, there is established an MBMS bearer which is a distribution route where communication quality for multicast data distribution between the SGSN 30 and NB 40 is secured.

Here, the NB 40 performs IP multicast participation processing (S314). The NB 40 references the MBMS bearer context 422 to perform participation request using the IP multicast address corresponding to the service. Specifically, in the event of performing communication using IPv4, the NB 40 transmits an IGMP Membership Report message, and in the event of performing communication using IPv6, transmits MLD Membership Report.

Thus, IP multicast packets are distributed to MBMS bearers established at the BM-SC 10, GGSN 20, SGSN 30, and NB 40. Also, multicast data is transmitted from the BM-SC 10 to the NB 40 by IP multicast.

Further, the NB 40 performs allocation processing of radio resources to be transmitted to the UE 50 (S312), and registers information to be distributed in the radio frame information 424. Specifically, the NB 40 registers mode information regarding whether the radio frame mode is the multicast mode or unicast mode for each service identifier. TMGI may be employed as a service identifier.

Also, in the event of transmitting frames in the multicast mode, UE information does not have to be held since frames are transmitted to an unspecified number of UE, but in the event of transmitting frames in the unicast mode, radio frames have to be transmitted to each UE, and accordingly, in this case, at the time of the activation procedure, IMSI is stored as UE information, and is registered as UE information.

According to the above service announcement procedure, MBMS registration procedure, and session start procedure, a communication path is established between the UE 50 and the BM-SC 10, the data transmitted from the BM-SC 10 can be distributed to the NB 40.

Lastly, the NB 40 transmits an MBMS start notification to the UE 50 (S316). A service identifier for identifying a service is informed by being included in the start notification. Thus, the UE 50 starts reception of multicast data.

Now, various identifiers are employed as a service identifier, but for example,

(1) TMGI to be registered in the MBMS bearer context 422,

(2) Session ID to be registered in the MBMS bearer context 422,

(3) Other identifiers (e.g., an identifier whereby an MBMS bearer service can be identified between the NB 40 and the UE 50),

and so forth are available. With the present embodiment, description will be made assuming that TMGI in (1) is employed, but in the case of (3), a service identifier and the MBMS bearer context 422 are registered in a correlated manner.

With the above example, description has been made regarding processing in the event that the GGSN 20 has received a session start request, but even in the event that another GGSN has received a session start request from the BM-SC 10, the GGSN thereof performs the same procedure as with the GGSN 20.

Similarly, with the SGSNs as well, description has been made regarding processing in the event that the SGSN 30 has received a session start request, but even in the event that another SGSN has received a session start request from a GGSN, the SGSN thereof performs the same procedure as with the SGSN 30.

Similarly, with the NBs as well, description has been made regarding processing in the event that the NB 40 has received a session start request, but even in the event that another NB has received a session start request from an SGSN, the NB thereof performs the same procedure as with the NB 40.

Similarly, with the UE as well, description has been made regarding processing in the event that the UE 50 has received a session start request, but even in the event that another UE has received a session start request from an NB, the UE thereof performs the same procedure as with the UE 50.

Thus, multicast data that the BM-SC 10 distributes is distributed to a UE via multiple GGSNs, SGSNs, and NBs in a stepwise manner.

Now, the MBMS bearer context 422 held by the NB 40 after the session start procedure is illustrated in (b) in FIG. 19. As illustrated in (b) in FIG. 19, “TMGI1” is stored in the MBMS bearer service identifier, “session 1” in the session identifier, “IP multicast address 1” in the IP multicast address, “multicast” in the mode, “active” in the status information, and information regarding “SGSN 30” in the higher-level distribution node, respectively. As compared to (a) in FIG. 19, the session identifier is newly stored, and the status information is changed from “standby” to “active”.

[1.3.5 MBMS deregistration Procedure and Session Stop Procedure]

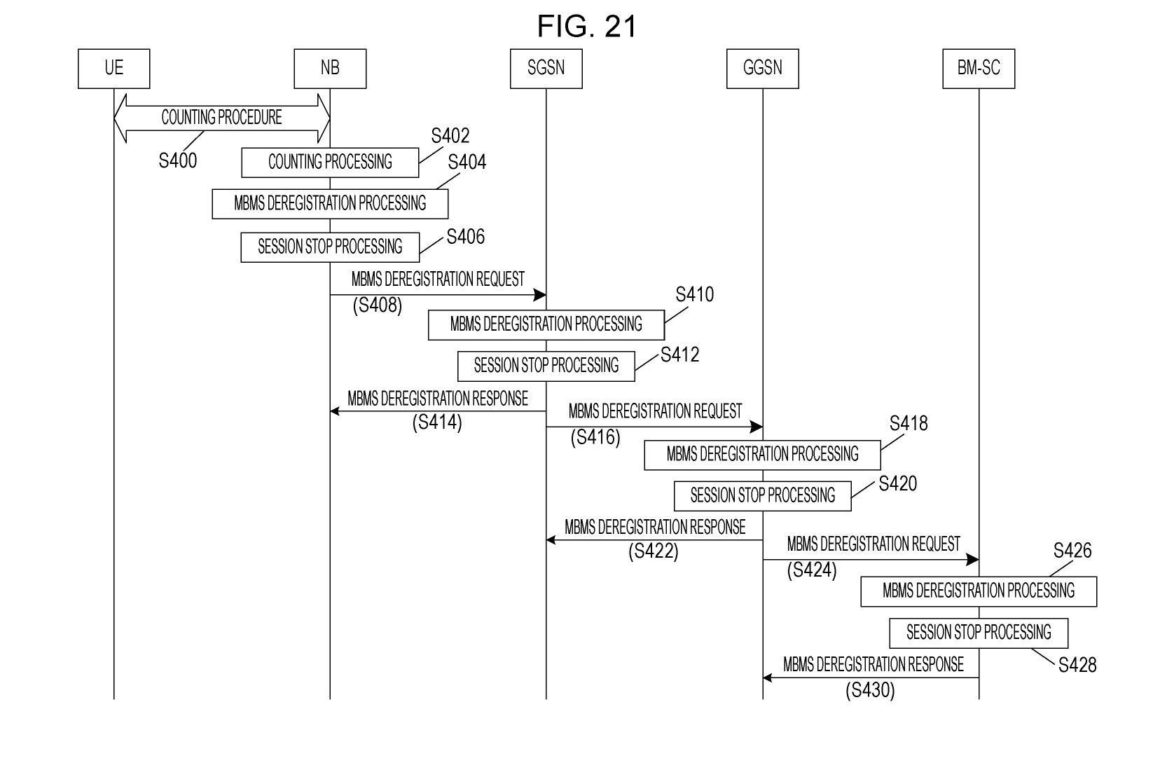

Next, the MBMS deregistration procedure and session stop procedure will be described with reference to FIG. 21.

With the present embodiment, description will be made so as to perform the session stop processing after the MBMS deregistration procedure, but the order is not restricted to this order, and the MBMS deregistration processing may be performed after the session stop processing. Also, with the MBMS deregistration processing, description will be made regarding an example wherein the procedure is started based on a counting procedure result at the NB 40, but the start trigger is not restricted to this, and the procedure may be started from the NB 40.

First, a counting procedure triggering the MBMS deregistration procedure will be described. The procedure will be performed between the NB 40 and the UE 50. The NB 40 transmits a message for confirming whether or not the NB 40 has received a service including a service identifier to the connected UE 50.

Now, the NB 40 transmits a message for confirming whether or not the NB 40 has received a service to the UE 50 registered in the radio frame information 424, but may be transmitted to all of the connected UE.

Now, various identifiers are employed as a service identifier, but for example,

(1) TMGI to be registered in the MBMS bearer context 422,

(2) Session ID to be registered in the MBMS bearer context 422,

(3) Other identifiers (e.g., an identifier whereby an MBMS bearer service can be identified between the NB 40 and the UE 50),

and so forth are available. With the present embodiment, description will be made assuming that TMGI in (1) is employed.

Thus, the NB 40 can obtain the number of UEs 50 to be actually used for reception of multicast data. The obtained number of UEs 50 is registered in the UE counter in the MBMS bearer context 422. As the number of UEs 50 to be actually used for reception of multicast data, there may be the number of UEs 50 connected to a base station, or the number of UEs 50 which participate in a multicast group out of these UEs 50. Further, this also may be a number obtained by detecting a state of viewpoint and listening applications not activated by the user or the like, and subtracting UEs 50 which user are temporarily not viewing and listening, or the number of UE 50 regarding which the user has made notification that reception is necessary, with the counted value being registered.

Also, the confirmation message of the NB 40 may be transmitted without a service identifier being included therein. In this case, when there is a service that requires reception, the UE 50 replies the message by including a service identifier therein. The service identifier can be selected by being obtained and stored in the service announcement procedure, or the like.

The NB 40 which has received the response determines the MBMS bearer context 422 from the service identifier, and registers the number of UEs 50 from which a response has been received, in the UE counter. Thus, the counting procedure (S400) is completed.

The NB 40 performs counting procedure to confirm whether or not the UE counter of the MBMS bearer context 422 has become zero (S402). In the event that the UE counter has become zero, the NB 40 performs MBMS deregistration processing (S404). The NB 40 references TMGI to be subjected to the counting processing, to delete UEs 50 from the distribution list of the corresponding MBMS bearer context 422.

Next, the NB 40 performs session stop processing (S406). Here, in the event that bearer resources are allocated to a service identified by TMGI between the UE 50 and the NB 40, the NB 40 releases the bearer resources thereof. Further, in the event that the status information in the MBMS bearer context 422 is “active”, the NB 40 sets this to “standby”.

Next, the NB 40 transmits an MBMS deregistration request of the corresponding service to the SGSN 30 (S408). The NB 40 determines an SGSN serving as a transmission destination with reference to the information of SGSN in the MBMS bearer context 422, and with the present embodiment, the NB 40 transmits to the SGSN 30. The NB 40 transmits the MBMS deregistration request including TMGI, service identifier, session identifier, and information of the NB 40 registered in the MBMS bearer context 422 to the SGSN 30.

The SGSN 30 which has received the MBMS deregistration request performs MBMS deregistration processing (S410). The SGSN 30 references TMGI included in the MBMS deregistration request received from the NB 40 to delete the NB 40 from the distribution list of the corresponding MBMS bearer context 322.

Next, the SGSN 30 performs session stop processing (S412). Here, in the event that bearer resources are allocated to a service identified by TMGI between the NB 40 and the SGSN 30, the SGSN 30 releases the bearer resources thereof. Further, in the event that the status information in the MBMS bearer context 322 is “active”, the SGSN 30 sets this to “standby”.

Next, the SGSN 30 transmits an MBMS deregistration response to the NB 40 (S414). The NB 40 which has received the MBMS deregistration response deletes the MBMS bearer context 422 corresponding to the TMGI which has been included in the MBMS deregistration request in S408.

The SGSN 30 confirms an NB (or identifier of an NB) in the distribution list in the MBMS bearer context 322, and in the event that an NB is registered, completes the present processing.

On the other hand, in the event that all of the NBs have been deleted from the distribution list in the MBMS bearer context 322 (EMPTY), the SGSN 30 transmits an MBMS deregistration request of the corresponding service to the GGSN 20 (S416). The GGSN serving as a transmission destination is determined by information of the GGSN in the MBMS bearer context 422, and with the present embodiment, the SGSN 30 transmits to the GGSN 20. The SGSN 30 transmits the MBMS deregistration request including TMGI, service identifier, session identifier, and information of the SGSN 30 registered in the MBMS bearer context 422 to the GGSN 20.

The GGSN 20 which has received the MBMS deregistration request performs MBMS deregistration processing (S418). The GGSN 20 references TMGI included in the MBMS deregistration request received from the SGSN 30 to delete the SGSN 30 from the distribution list of the corresponding MBMS bearer context 222. Next, the GGSN 20 performs session stop processing (S420). Here, in the event that bearer resources are allocated to a service identified by TMGI between the SGSN 30 and the GGSN 20, the GGSN 20 releases the bearer resources thereof. Further, in the event that the status information in the MBMS bearer context 222 is active, the GGSN 20 sets this to standby.

Next, the GGSN 20 transmits an MBMS MBMS deregistration response to the SGSN 30 (S422). The SGSN 30 which has received the MBMS deregistration response deletes the MBMS bearer context 222 corresponding to the TMGI which has been included in the MBMS deregistration request in S416.

The GGSN 20 confirms an SGSN (or identifier of an SGSN) in the distribution list in the MBMS bearer context 222, and in the event that an SGSN is registered, completes the present processing.

On the other hand, in the event that all of the SGSNs have been deleted from the distribution list in the MBMS bearer context 222 (EMPTY), the GGSN 20 transmits an MBMS deregistration request of the corresponding service to the BM-SC 10 (S424). The BM-SC serving as a transmission destination is determined by information of the BM-SC in the MBMS bearer context 124, and with the present embodiment, the GGSN 20 transmits to the BM-SC 10. The GGSN 20 transmits the MBMS deregistration request including TMGI, service identifier, session identifier, and information of the GGSN 20 registered in the MBMS bearer context 222 to the BM-SC 10.

The BM-SC 10 which has received the MBMS deregistration request performs MBMS deregistration processing (S426). The BM-SC 10 references TMGI included in the MBMS deregistration request received from the GGSN 20 to delete the GGSN 20 from the distribution list of the corresponding MBMS bearer context 124. Next, the BM-SC 10 performs session stop processing (S428). Here, in the event that bearer resources are allocated to a service identified by TMGI between the GGSN 20 and the BM-SC 10, the BM-SC 10 releases the bearer resources thereof. Further, in the event that the status information in the MBMS bearer context 124 is active, the BM-SC 10 sets this to standby.

Next, the BM-SC 10 transmits an MBMS MBMS deregistration response to the GGSN 20 (S430). The GGSN 20 which has received the MBMS deregistration response deletes the MBMS bearer context 124 corresponding to the TMGI which has been included in the MBMS deregistration request in S424. Further, in the event of holding the MBMS UE context 226 corresponding to TMGI included in the MBMS deregistration request, the GGSN 20 may delete all of the MBMS UE contexts 226 including the TMGI thereof.

The BM-SC 10 deletes the MBMS bearer context 124 identified by TMGI included in the MBMS deregistration request. The BM-SC 10 confirms the GGSN 20 (or identifier of the GGSN 20) in the distribution list in the MBMS bearer context 124, and in the event that the GGSN 20 is registered, completes the present processing.

On the other hand, in the event that all of the GGSNs have been deleted from the distribution list in the MBMS bearer context 124 (EMPTY), the BM-SC 10 deletes the MBMS bearer context 124.

According to the above procedure, MBMS registration can effectively be cancelled using the counting function by the NB 40. With the MBMS deregistration procedure of the NB 40, it can be detected by the counting procedure that distribution of a multicast service for each MBMS bearer that can be identified by TMGI or the like is unnecessary.

Further, as with a case where the user is prevented from viewing due to inactivation of an application or the like, the MBMS deregistration procedure may also be started by detecting that the user is not viewing. The MBMS deregistration procedure may be started, triggered by this detection.

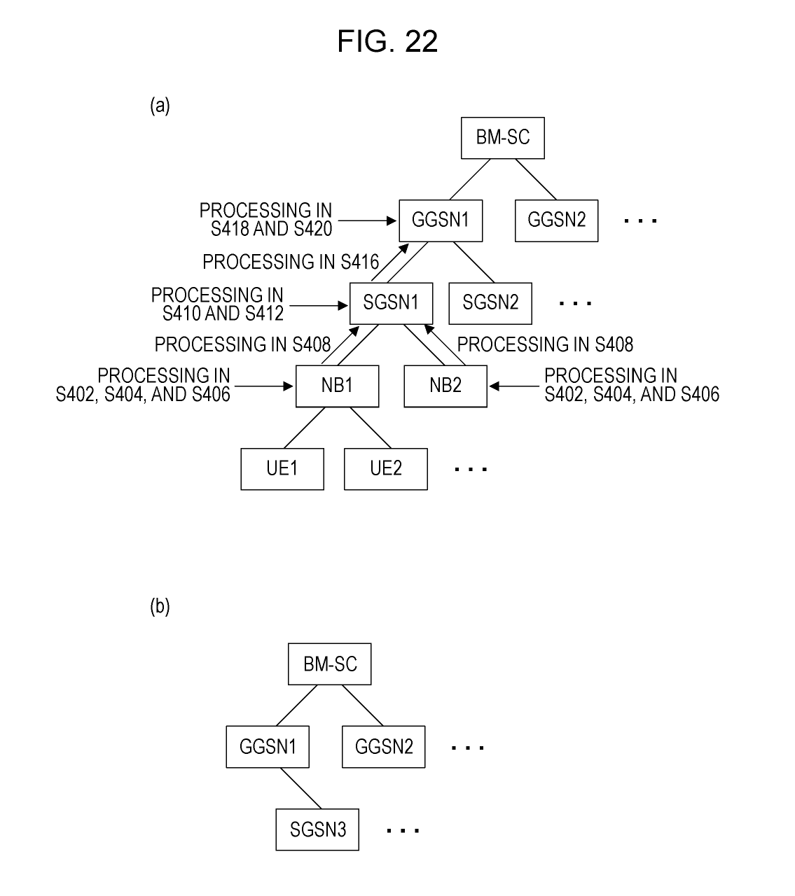

(a) in FIG. 22 illustrates a distribution tree before the MBMS deregistration procedure and session stop processing, and (b) in FIG. 22 illustrates a distribution tree after the MBMS deregistration procedure and session stop processing. The distribution tree illustrates a route where data is distributed from a BM-SC to UE via GGSN, SGSN, and NB.

FIG. 22 illustrates that an NB 1 and an NB 2 each perform the counting processing on an optional service (S402), the UE counter becomes zero, and the MBMS registration procedure and session processing are started.

The NB 1 and NB 2 which have determined to perform the MBMS deregistration procedure and session stop processing each perform MBMS deregistration processing (S404). Specifically, UE connected to the NB 1 or UE connected to the NB 2 is deleted from the distribution list in the MBMS bearer context 422.

Also, the NB 1 and NB2 each perform session stop processing (S406). Specifically, in the event that bearer resources are allocated between the UE connected to an NB 1 and the UE connected to an NB 1, the bearer resources thereof are released, and in the event that bearer resources are allocated between the UE connected to an NB 2 and the UE connected to an NB 2, the bearer resources thereof are released.

Next, the NB1 and NB2 each transmit an MBMS deregistration request to an SGSN 1 (S408). The SGSN 1 performs MBMS deregistration processing based on the MBMS deregistration requests from the NB 1 and NB 2 (S410). Specifically, the SGSN 1 deletes the NB 1 and NB 2 from the distribution list of the MBMS bearer context 322 held by the SGSN 1.

Next, the SGSN 1 performs session stop processing (S412). Specifically, in the event that bearer resources are allocated between the SGSN 1 and the NB 1 or NB 2, the bearer resources thereof are released. Here, the SGSN 1 confirms that the distribution list in the MBMS bearer context 322 is EMPTY, and transmits an MBMS deregistration request to the GGSN 1 (S416). The GGSN 1 performs MBMS deregistration processing based on the MBMS deregistration request from the SGSN 1 (S418). Specifically, the GGSN 1 release the SGSN 1 from the distribution list in the MBMS bearer context 222 held by the GGSN.

Next, the GGSN 1 performs session stop processing (S420). Specifically, in the event that bearer resources are allocated between the GGSN 1 and SGSN 1, the bearer resources thereof are released. Here, the SGSN 2 is registered in the distribution list in the MBMS bearer context 222 at the GGSN 1, and accordingly, the GGSN 1 completes the MBMS deregistration processing. According to the distribution tree after the MBMS deregistration procedure and session stop processing, it can be understood that the SGSN 1 has been deleted from the distribution list of the GGSN 1.

With the above procedure, deactivation processing (service deregistration by UE) has not been performed. In the event that UE can detect using the counting function or the like that there is a request for service reception, the NB 40 can resume service reception without performing activation processing.

On the other hand, the MBMS deregistration has been performed, triggered by the UE counter having become zero using the counting function by the NB 40, but the MBMS deregistration procedure may be performed triggered by all of the MBMS UE contexts in a certain service having been deleted after performing the deactivation procedure. In the event of having performed a deactivation registration procedure, this service is excluded from service registration of a BM-SC, and accounting processing can be stopped.

In this manner, each device recognizes that a service to be registered is in the multicast mode, the BM-SC 10 registers multicast in the mode of the MBMS bearer context 124, the GGSN 20 registers multicast in the mode of the MBMS bearer context 222, the SGSN 30 registers multicast in the mode of the MBMS bearer context 322, and the NB 40 registers multicast in the mode of the MBMS bearer context 422.

Thus, in the event of determining MBMS deregistration, MBMS registration can be cancelled when the modes are the multicast mode with reference to each of the MBMS bearer context 124 at the BM-SC 10, the MBMS bearer context 222 at the GGSN 20, the MBMS bearer context 322 at the SGSN 30, and the MBMS bearer context 422 at the NB 40.

Further, in the above case, in the event that the status information in the MBMS bearer context 124 at the BM-SC 10, the MBMS bearer context 222 at the GGSN 20, the MBMS bearer context 322 at the SGSN 30, and the MBMS bearer context 422 at the NB 40 is active, the status information is changed to standby, whereby session stop, multicast data distribution, and reception stop can be performed.

Specifically, at the time of transmission of a multicast MBMS deregistration request (S408), in the event that the mode of the MBMS bearer context 422 is multicast, the NB 40 performs transmission of an MBMS deregistration request, MBMS deregistration processing, release of an MBMS bearer, multicast data distribution, or reception stop.

At the time of transmission of a multicast MBMS deregistration request (S416), in the event that the mode of the MBMS bearer context 322 is multicast, the SGSN 30 performs transmission of an MBMS deregistration request, MBMS deregistration processing, release of an MBMS bearer, multicast data distribution, or reception stop.

At the time of transmission of a multicast MBMS deregistration request (S424), in the event that the mode of the MBMS bearer context 222 is multicast, the GGSN 20 performs transmission of an MBMS deregistration request, release of an MBMS bearer, multicast data distribution, or reception stop.

At the time of reception of a multicast MBMS deregistration request (S424), in the event that the mode of the MBMS bearer context 222 is multicast, the BM-SC 10 performs transmission of an MBMS deregistration request, release of an MBMS bearer, or multicast data distribution stop.

Heretofore, it has been stipulated that MBMS registration is cancelled under the initiative of the NB 40 which is a base station device, in the event that necessity of reception of a mobile station device has been confirmed at the base station device and unnecessity of distribution has been able to be detected without performing the activation procedure nor deactivation procedure, MBMS registration has not been able to effectively be cancelled. With the present embodiment, a base station device can perform the MBMS deregistration procedure and session stop procedure based on a result of necessity/unnecessity of reception of a mobile station device without performing the activation procedure nor deactivation procedure.

Also, deletion of a distribution destination device from the distribution list and also release of resources that has heretofore been performed can be performed by the MBMS deregistration procedure alone. Further, the session stop procedure necessary for session stop can be omitted and accordingly simplified. Also, at the time of MBMS deregistration, in the event that the session is not stopped, the session is not started unless MBMS registration is performed again by performing MBMS deregistration and also session stop.

For example, with a conventional technique, only a procedure to stop a session from a distribution source to a distribution destination has been stipulated, and session stop from a base station device (NB) to a distribution source has been unavailable. Further, even if the procedure is expanded so as to request session stop from a base station device (NB) to a distribution source, a device which has received a session stop request can stop distribution and temporarily release the resources, but deletion of a distribution list is not performed.

Accordingly, for example, heretofore, 1) in a state in which a session has been started, 2) in an event that a session alone has been stopped under the initiative of the NB, 3) after all of sessions have been stopped under the initiative of the BM-SC, 4) in the event that all of sessions have been resumed under the initiative of the BM-SC, communication resources have been allocated to all of nodes (GGSN, SGSN, NB) included in the distribution list, and consequently, even a session stopped under the initiative of the NB has also been resumed, which has been a problem.

However, updating of a distribution destination device has been performed from the distribution list by the MBMS deregistration procedure, and for example, in the event that a session has been resumed under the initiative of the BM-SC as with 4) as well, an unnecessary session is prevented from being started.

According to the present embodiment, a session is not unnecessarily started, and accordingly, exchange of control information necessary at the time of starting a session can be reduced, and communication resources can effectively be utilized without ineffectively using communication resources necessary for the session start procedure.

The fact that a session is not started means that communication resources can be effectively utilized without communication resources being unnecessarily used. Also, due to a session not being unnecessarily started, exchange of control information necessary at the time of starting a session can be reduced, and communication resources can effectively be utilized without communication resources necessary for a session start procedure being ineffectively used.

### 2. Second Embodiment

Next, a second embodiment will be described. With the second embodiment, a system for broadcast distribution performs an MBMS deregistration procedure using the counting function.

With the first embodiment, the MBMS registration procedure has been started by performing the activation procedure and service registration from UE, but in the case of broadcast, the MBMS registration procedure can be performed without performing the activation procedure. Now, with broadcast distribution, unlike multicast distribution, the activation procedure is not performed, and accordingly, no MBMS UE context is generated.

Note that a system configuration and device configurations according to the second embodiment are the same as those according to the first embodiment, and accordingly, description thereof will be omitted.

Note that, at a system for broadcast distribution, service registration is not required from UE 50, and no activation procedure occurs. Therefore, no MBMS UE context is created at each of the NB 40, SGSN 30, GGSN 20, and BM-SC 10, which differs from the first embodiment.

Also, while description has been made regarding “multicast service” with the first embodiment, description will be made regarding application to “broadcast service” with the second embodiment. For example, a UE counter according to the second embodiment is the number of the UE necessary for reception of broad data of the MBMS bearer service. This is based on the number counted by the counting function of the base station device (NB 40), and may be, for example, the number of UEs 50 themselves connected to the NB 40. Further, this may be the number of terminals (UE 50) which users are actually viewing and listening to, for example, i.e., a number obtained by detecting a state of viewpoint and listening applications not activated by the user or the like, and subtracting UEs 50 which users are temporarily not viewing and listening, or the number of UEs 50 regarding which the user has made notification that reception is necessary.

[2.1 Flow of Processing]

Now, a flow of processing according to the second embodiment will be described with reference to the drawing.

[2.1.1 Service Announcement Procedure]

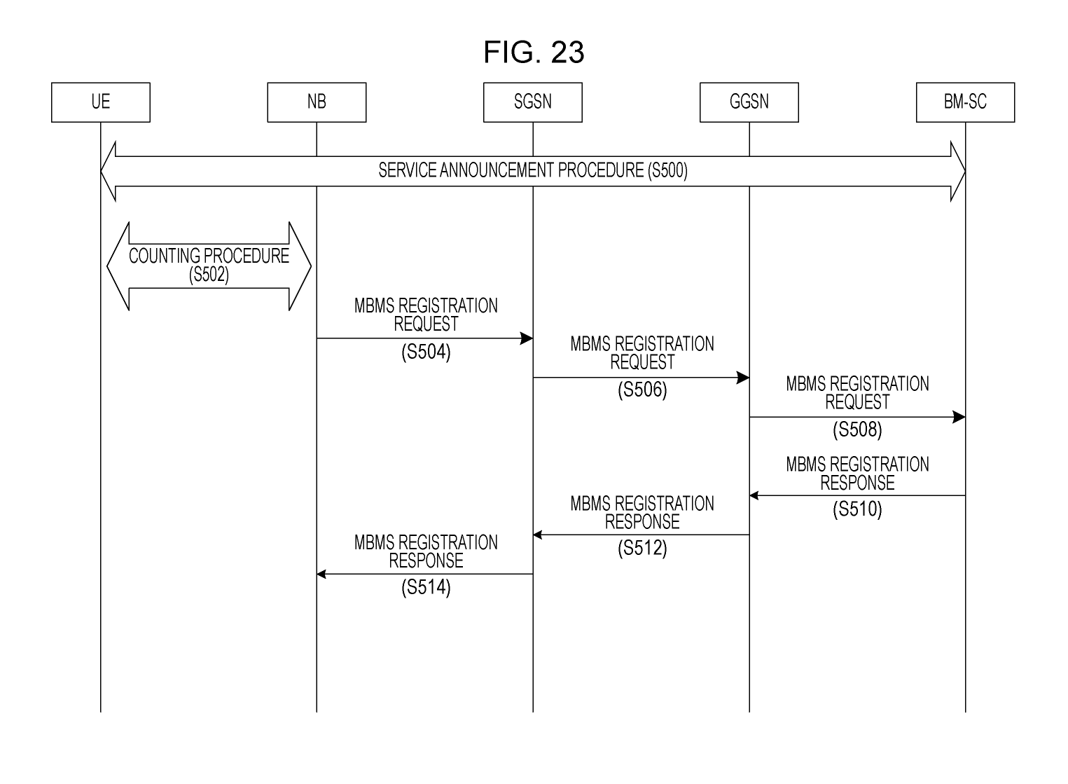

A service announcement procedure according to the present embodiment will be described. As illustrated in FIG. 23, the BS-MC 10 first performs the service announcement procedure on the UE 50. The BM-SC 10 informs the UE 50 of a distributable service (S500). Thus, the UE 50 detects a broadcast service.

The BM-SC 10 informs the UE 50 that distribution of a service managed at the MBMS service DB 122 can be performed by informing a service identifier. Further, a service identifier may be informed by adding information for describing a service, such as a program title, a content title, distribution start time, and so forth, thereto.

Now, various identifiers are employed as a service identifier, but for example,

(1) TMGI,

(2) Other identifiers (e.g., other identifiers whereby an MBMS bearer service set by a provider can be identified), and so forth are available. With the present embodiment, description will be made assuming that TMGI in (1) is employed.

Also, as a specific informing method, various methods can be conceived, but for example, an SMS (Short Message Service) or the like is employed to inform a distributable service to a distributable UE 50 registered beforehand or unspecified number of UEs 50, or information is displayed on a website to obtain the information by the UE 50 accessing a web server.

[2.1.2 MBMS Registration Procedure]

Next, an MBMS registration procedure will be described. The MBMS registration procedure according to an MBMS service is illustrated in FIG. 23. According to the MBMS registration procedure, a communication path from the BM-SC 10 to the UE 50 is established.

In order to establish a communication path, it is necessary to generate the MBMS bearer context 124 at the BM-SC 10, the MBMS bearer context 222 at the GGSN 20, the MBMS bearer context 322 at the SGSN 30, and the MBMS bearer context 422 at the NB 40, and to register each distribution node list within the MBMS bearer context 124 at the BM-SC10, the MBMS bearer context 222 at the GGSN 20, the MBMS bearer context 322 at the SGSN 30, and the MBMS bearer context 422 at the NB 40. Each of the MBMS bearer context 124, MBMS bearer context 222, MBMS bearer context 322, and MBMS bearer context 422 can be identified by TMGI.

Specifically, the GGSN 20 is registered in the distribution list at the BM-SC 10, the SGSN 30 is registered in the distribution list at the GGSN 20, and the NB 40 is registered in the distribution list at the SGSN 30, respectively. Also, multiple downlink nodes may be registered in each distribution list at the BM-SC 10, GGSN 20, SGSN 30, and NB 40.

First, the NB 40 starts the MBMS registration procedure by detecting UE receiving an MBMS service. Here, there are various methods for the NB 40 detecting the UE receiving an MBMS service, but for example, the UE 50 receiving an MBMS service may be detected using the counting function at the NB 40. In other words, according to the counting procedure, the UE 50 can require MBMS registration from the NB 40.

First, the NB 40 transmits a message for confirming whether or not a service including a service identifier has been received to the connected UE 50.

Now, the NB 40 transmits a message confirming whether a service has been received to a UE 50 registered in the radio frame information 424, but may be transmitted to all of connected UE.

Now, various identifiers are employed as a service identifier, but for example,

(1) TMGI registered in the MBMS bearer context 422,

(2) Session ID registered in the MBMS bearer context 422,

(3) Other identifiers (e.g., an identifier whereby an MBMS bearer service can be identified between the NB 40 and UE 50),

and so forth are available. With the present embodiment, description will be made assuming that TMGI in (1) is employed.

Thus, the NB 40 can obtain the number of UEs 50 which actually require reception of broadcast data. The number of obtained UEs 50 is registered in the UE counter in the MBMS bearer context 422. Examples of the number of UEs 50 which actually requires reception of broadcast data may be include the number of UEs 50 connected to an NB 40, for example. Further, this may be a number obtained by detecting a state of viewpoint and listening applications not activated by the user or the like, and subtracting UEs 50 which users are temporarily not viewing and listening, or the number of UE 50 regarding which the user has made notification that reception is necessary may be counted and registered.

Also, the confirmation message from the NB 40 may be transmitted by a service identifier being excluded therefrom. In this case, when there is a service that requires reception, the UE 50 replies to the message by including a service identifier in a response.

The service identifier can be selected by being stored beforehand such as being obtained by the service announcement procedure.

The NB 40 which has received the response determines an MBMS bearer context 422 from the service identifier, and registers the number of UEs 50 from which a response has been received in the UE counter. Thus, the counting procedure is completed (S502). As a result of the counting procedure, in the event that determination is made that the UE counter is not zero, the MBMS registration procedure may be started.

Further, a trigger for the NB 40 to start the MBMS registration procedure may be performed at optional timing according to the operator's policy. A trigger other than the above may be performed at optional timing such as at the time of installation of a base station, at the time of start of operation, or the like according to the operator's policy.

Next, the NB 40 transmits an MBMS registration request for MBMS registration of a service specified at UE to the SGSN 30 (S504). Here, the NB 40 includes TMGI and an IP multicast address in the MBMS registration request.

The SGSN 30 which has received the MBMS registration request from the NB 40 transmits the MBMS registration request to the GGSN 20 (S506). Here, the SGSN 30 includes TMGI and an IP multicast address in the MBMS registration request.

Now, the SGSN 30 generates an MBMS bearer context 322 corresponding to the service. The SGSN 30 includes TMGI for identifying the service in the MBMS bearer context 322. Further, the SGSN 30 sets the status information of the bearer resources in the MBMS bearer context 322 to “standby”.

The GGSN 20 which has received the MBMS registration request from the SGSN 30 generates an MBMS bearer context 222, and transmits the MBMS registration request to the BM-SC 10 (S508). Here, GGSN 20 sets the status information of the bearer resources in the MBMS bearer context 222 to “standby”.

The BM-SC 10 which has received the MBMS registration request from the GGSN 20 registers the identifier of the GGSN 20 which has transmitted the MBMS registration request in the distribution list in the MBMS bearer context 124, and sends back an MBMS registration response (S510). Here, the BM-SC 10 includes TMGI and the capacity of a bearer necessary for the service in the MBMS registration response.

The GGSN 20 which has received the MBMS registration request from the SGSN 30 in S506 registers the identifier of the SGSN 30 which has transmitted the MBMS registration request in the distribution list of the MBMS bearer context 222, and sends back an MBMS registration response (S512). Here, the GGSN 20 includes TMGI and information regarding a bearer necessary for this MBMS service in the MBMS registration response.

The SGSN 30 which has received the MBMS registration request from the NB 40 in S504 registers the identifier of the NB 40 which has transmitted the MBMS registration request in the distribution list of the MBMS bearer context 322, and transmits an MBMS registration response (S514).

According to the above service announcement procedure and MBMS registration procedure, a distribution list is formed between the UE 50 and the BM-SC 10, whereby a route for distributing broadcast distribution data of the service transmitted from the BM-SC 10 to the NB 40 can be generated. Note that a node registered in the distribution list does not have to follow the above, and may be registered by the operator beforehand.

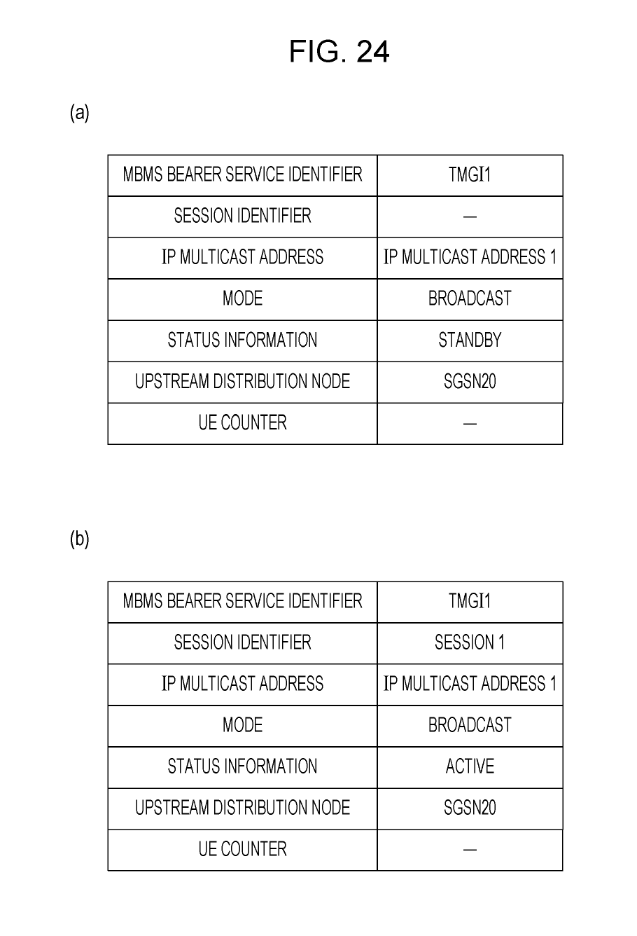

Now, (a) in FIG. 24 illustrates the MBMS bearer context 422 held by the NB 40 after the MBMS registration procedure. As illustrated in (a) in FIG. 24, “TMGI1” is stored in the MBMS bearer service identifier, “IP multicast address 1” in the IP multicast address, “broadcast” in the mode, “standby” in the status information, and “SGSN 20” in the higher-level distribution node, respectively.

With the above example, description has been made regarding processing in the event that the SGSN 30 has received the MBMS deregistration request, but even in the event that another SGSN has received an MBMS deregistration request from the NB 40, the SGSN thereof performs the same procedure as with the SGSN 30.

Similarly, at the GGSN 20 as well, description has been made regarding processing in the event that the GGSN 20 has received the MBMS registration request, but even in the event that another GGSN has received the MBMS registration request from the SGSN 30, the GGSN thereof performs the same procedure as with the GGSN 20.

Similarly, at the BM-SC 10 as well, description has been made regarding processing in the event that the BM-SC 10 has received the MBMS deregistration request, but even in the event that another BM-SC has received the MBMS deregistration request from the GGSN 20, the BM-SC thereof performs the same procedure as with the BM-SC 10.

[2.1.3 Session Start Procedure]

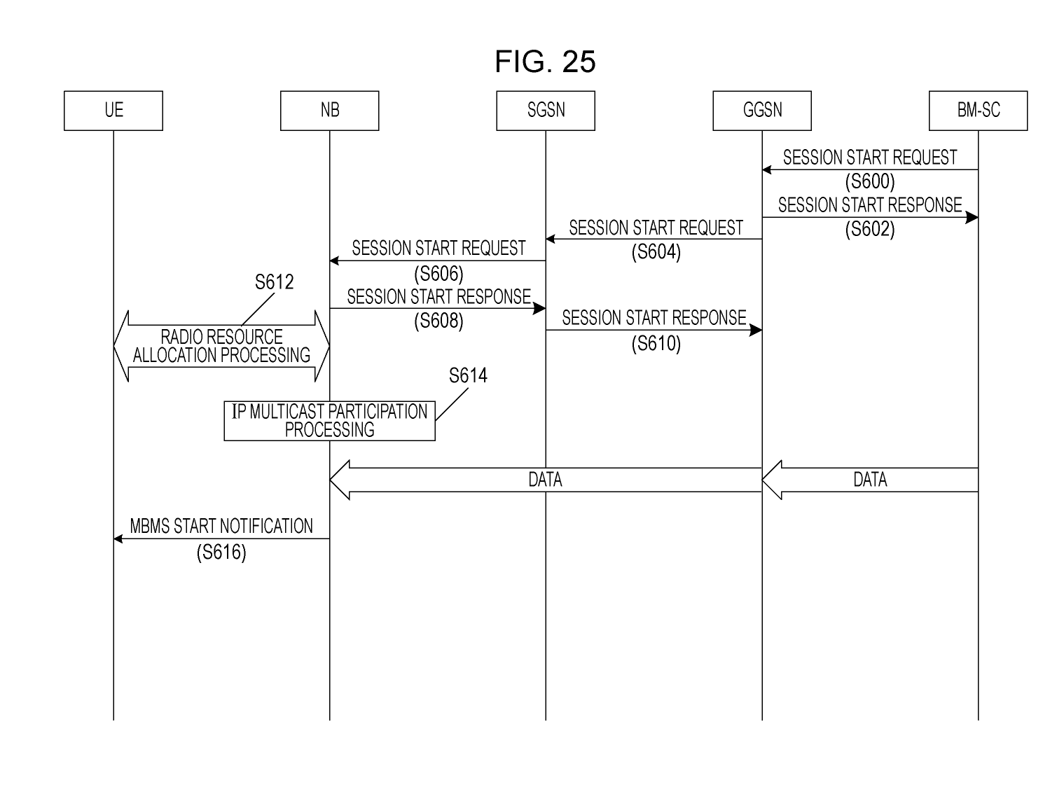

The session start procedure to be executed next will be described with reference to FIG. 25. According to the session start procedure, an MBMS bearer is established, and preparation for transmitting data is performed. The BM-SC 10 specifies a service, and transmits a session start request to the GGSN 20 (S600). Here, the BM-SC 10 generates a session identifier for identifying a session, and transmits the generated session identifier and TMGI for specifying a service by being included in the session start request. Thus, the session start procedure is started.

Also, the BM-SC 10 registers a session identifier in the corresponding MBMS bearer context 124 (identifiable by TMGI), and registers “active” in the status information.

Also, the session start request is transmitted to all of the GGSNs registered in the distribution node in the MBMS bearer context 124.

The GGSN 20 receives the session start request, transmits a session start response to the BM-SC 10, and replies to the request (S602). Also, the GGSN 20 registers a session identifier in the corresponding MBMS bearer context 222 (identifiable by TMGI), and registers active in the status information. Information regarding the SGSN 30 is registered in the distribution list. Here, multiple SGSNs are registered in the distribution node.

Note that the SGSN 30 which is a distribution node to be registered may be registered beforehand by the operator, or the corresponding SGSN 30 may be selected based on the MBMS service area identifier included in the session start request transmitted from the BM-SC 10 using the list of distribution nodes (SGSN 30 and others) for each MBMS service area registered through the above MBMS registration procedure.

According to the above procedure, there is established an MBMS bearer which is a distribution route where communication quality is secured for broadcast data distribution between the BM-SC 10 and the GGSN 20.

Further, transmission with an MBMS bearer is performed by IP multicast communication, and accordingly, an IP multicast address is allocated to the service, and is registered in the MBMS bearer context 222.

The GGSN 20 transmits a session start request to the SGSN 30 registered in the distribution node in the MBMS bearer context 222 (S604). In order to specify a service, TMGI, a session identifier, and an IP multicast address are included in the session start request.

Also, the session start request is transmitted to all of the SGSNs registered in the distribution node in the MBMS bearer context 222.

The SGSN 30 receives the session start request, transmits a session start response to the GGSN 20 to reply to the request (S610). Also, the SGSN 30 registers TMGI, a session identifier, and an IP multicast address in the MBMS bearer context 322, and registers active in the status information.

Information regarding the NB 40 is registered in the distribution node. Here, multiple NBs are registered in the distribution node.

According to the above procedure, there is established an MBMS bearer which is a distribution route where communication quality of broadcast data distribution between the GGSN 20 and the SGSN 30 is secured.

The SGSN 30 transmits the session start request (S606) to the NB 40 registered in the distribution node of the MBMS bearer context 322. The session start request includes TMGI, a session identifier, and an IP multicast address.

Also, the session start request is transmitted to all of the NBs registered in the distribution node in the MBMS bearer context 322.

The NB 40 receives the session start request, and transmits a session start response to the SGSN 30 to reply the request (S608). Also, the NB 40 generates an MBMS bearer context 422, registers TMGI and a session identifier, and an IP multicast address, and registers active in the status information. Further, the NB 40 registers information regarding the SGSN 30 serving as a higher-level distribution node which has transmitted the request.

According to the above procedure, there is established an MBMS bearer which is a distribution route where communication quality for broadcast data distribution is secured between the SGSN 30 and the NB 40.

Thus, IP multicast packets are distributed to MBMS bearers established at the BM-SC 10, GGSN 20, SGSN 30, and NB 40. Also, broadcast data is transmitted from the BM-SC 10 to the NB 40 by IP multicast.

Now, the NB 40 performs IP multicast participation processing (S614). The NB 40 references the MBMS bearer context 422 to perform participation request using the IP multicast address corresponding to the service.

Specifically, in the event of performing communication using IPv4, an IGMP Membership Report message is transmitted, and in the event of performing communication using IPv6, MLD Membership Report is transmitted.

Further, the NB 40 performs allocation processing of radio resources to be distributed to the UE 50 (S612) to register information for distribution in the radio frame information 424. Specifically, the NB 40 registers mode information whether the mode of radio frames is the broadcast mode or unicast mode, for each service identifier. TMGI may be employed as the service identifier.

Also, in the event of transmitting radio frames in the broadcast mode, UE information for transmitting frames to an unspecified number of UE does not have to be held, but in the event of transmitting radio frames in the unicast mode, radio frames have to be transmitted to each UE, and accordingly, in this case, at the time of the activation procedure, IMSI is held as UE information, and is registered as UE information.

According to the above service announcement procedure, MBMS registration procedure, and session start procedure, a communication path is established between the UE 50 and the BM-SC 10, and the data transmitted from the BM-SC 10 can be distributed to the NB 40.

Lastly, the NB 40 transmits an MBMS start notification to the UE 50 (S616). A service identifier for identifying a service is informed by being included in the start notification. Thus, the UE 50 starts reception of broadcast data.

Now, various identifiers are employed as a service identifier, but for example,

(1) TMGI to be registered in the MBMS bearer context 422,

(2) Session ID to be registered in the MBMS bearer context 422,

(3) Other identifiers (e.g., an identifier whereby an MBMS bearer service can be identified between the NB 40 and the UE 50),

and so forth are available. With the present embodiment, description will be made assuming that TMGI in (1) is employed, but in the case of (3), a service identifier and the MBMS bearer context 422 are registered in a correlated manner.

With the above example, description has been made regarding processing in the event that the GGSN 20 has received a session start request, but even in the event that another GGSN has received a session start request from the BM-SC 10, the GGSN thereof performs the same procedure as with the GGSN 20.

Similarly, with the SGSNs as well, description has been made regarding processing in the event that the SGSN 30 has received a session start request, but even in the event that another SGSN has received a session start request from a GGSN, the SGSN thereof performs the same procedure as with the SGSN 30.

Similarly, with the NBs as well, description has been made regarding processing in the event that the NB 40 has received a session start request, but even in the event that another NB has received a session start request from an SGNS, the NB thereof performs the same procedure as with the NB 40.

Similarly, with the UE as well, description has been made regarding processing in the event that the UE 50 has received a session start request, but even in the event that another UE has received a session start request from an NB, the UE thereof performs the same procedure as with the UE 50.

Thus, broadcast data that the BM-SC 10 distributes is distributed to a UE via multiple GGSNs, SGSNs, and NBs in a stepwise manner.

Now, the MBMS bearer context 422 held by the NB 40 after the session start procedure is illustrated in (b) in FIG. 24. As illustrated in (b) in FIG. 24, “TMGI1” is stored in the MBMS bearer service identifier, “session 1” in the session identifier, “IP multicast address 1” in the IP multicast address, “broadcast” in the mode, “active” in the status information, and information regarding “SGSN 20” in the higher-level distribution node, respectively. As compared to (a) in FIG. 24, the session identifier is newly stored, and the status information is changed from “standby” to “active”.

[2.1.4 MBMS deregistration Procedure and Session Stop Procedure]

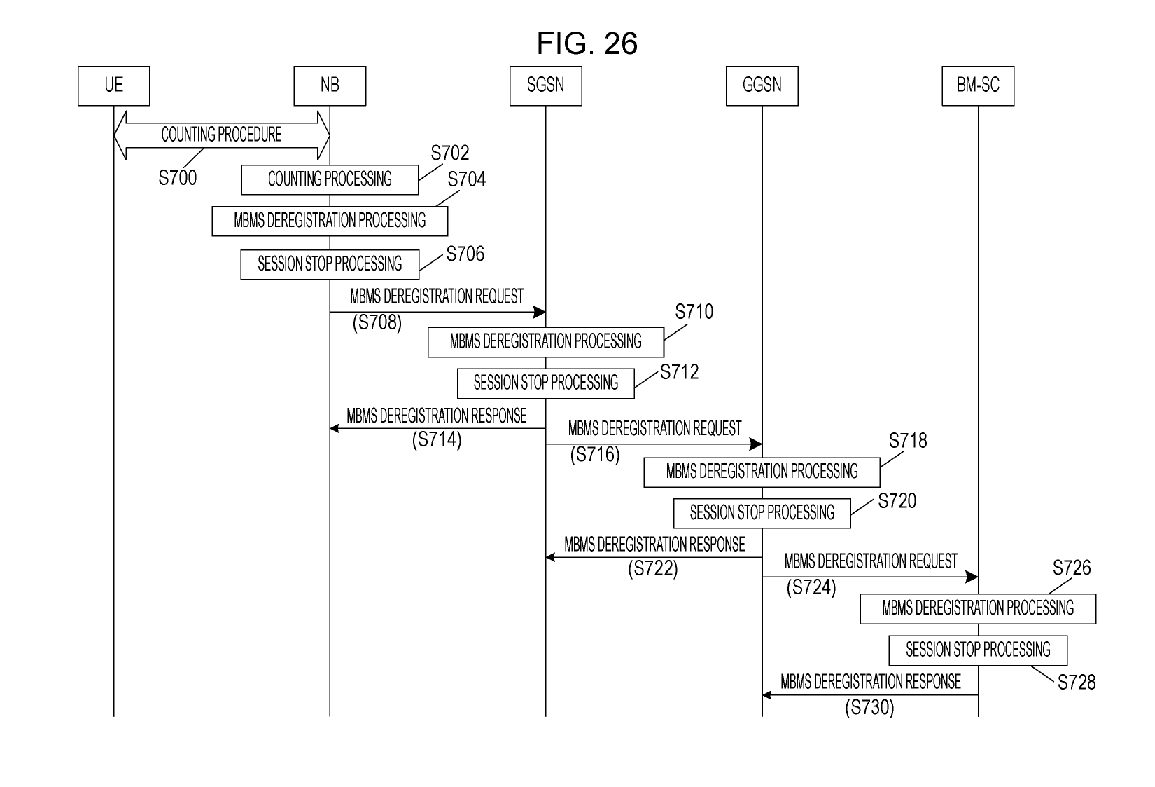

Next, the MBMS deregistration procedure and session stop procedure will be described with reference to FIG. 26.

With the present embodiment, description will be made so as to perform the session stop processing after the MBMS deregistration processing, but the order is not restricted to this order, and the MBMS deregistration processing may be performed after the session stop processing procedure. Also, with the MBMS deregistration procedure, description will be made regarding an example wherein the procedure is started based on a counting procedure result at the NB 40, but the start trigger is not restricted to this, and the procedure may be started from the NB 40.

First, a counting procedure triggering the MBMS deregistration procedure will be described. The procedure will be performed between the NB 40 and the UE 50. The NB 40 transmits a message for confirming whether or not the NB 40 has received a service including a service identifier to the connected UE 50.

Now, the NB 40 transmits a message for confirming whether or not the NB 40 has received a service to the UE 50 registered in the radio frame information 424, but may be transmitted to all of the connected UE.

Now, various identifiers are employed as a service identifier, but for example,

(1) TMGI to be registered in the MBMS bearer context 422,

(2) Session ID to be registered in the MBMS bearer context 422,

(3) Other identifiers (e.g., an identifier whereby an MBMS bearer service can be identified between the NB 40 and the UE 50),

and so forth are available. With the present embodiment, description will be made assuming that TMGI in (1) is employed.

Thus, the NB 40 can obtain the number of UEs 50 to be actually used for reception of multicast data. The obtained number of UEs 50 is registered in the UE counter in the MBMS bearer context 422.

Also, the confirmation message of the NB 40 may be transmitted without a service identifier being included therein. In this case, when there is a service that requires reception, the UE 50 replies the message by including a service identifier therein.

The service identifier can be selected by being obtained and stored in the service announcement procedure, or the like.

The NB 40 which has received the response determines the MBMS bearer context 422 from the service identifier, and registers the number of UE 50 from which a response has been received, in the UE counter. Thus, the counting procedure (S700) is completed.

The NB 40 performs counting procedure to confirm whether or not the UE counter of the MBMS bearer context 422 has become zero (S702). In the event that the UE counter has become zero, the NB 40 performs MBMS deregistration processing (S704). The NB 40 references TMGI to be the subject of the counting processing, to delete UEs 50 from the distribution list of the corresponding MBMS bearer context 422.

Next, the NB 40 performs session stop processing (S706). Here, in the event that bearer resources are allocated to a service identified by TMGI between the UE 50 and the NB 40, the NB 40 releases the bearer resources thereof. Further, in the event that the status information in the MBMS bearer context 422 is “active”, the NB 40 sets this to “standby”.

Next, the NB 40 transmits an MBMS deregistration request of the corresponding service to the SGSN 30 (S708). The NB 40 determines an SGSN serving as a transmission destination with reference to the information of SGSN in the MBMS bearer context 422, and with the present embodiment, the NB 40 transmits to the SGSN 30. The NB 40 transmits the MBMS deregistration request including TMGI, service identifier, session identifier, and information of the NB 40 registered in the MBMS bearer context 422 to the SGSN 30 (S708).

The SGSN 30 which has received the MBMS deregistration request performs MBMS deregistration processing (S710). The SGSN 30 references TMGI included in the MBMS deregistration request received from the NB 40 to delete the NB 40 from the distribution list of the corresponding MBMS bearer context 322. Next, the SGSN 30 performs session stop processing (S712). Here, in the event that bearer resources are allocated to a service identified by TMGI between the NB 40 and the SGSN 30, the SGSN 30 releases the bearer resources thereof. Further, in the event that the status information in the MBMS bearer context 322 is active, the SGSN 30 sets this to standby.

Next, the SGSN 30 transmits an MBMS deregistration response to the NB 40 (S714). The NB 40 which has received the MBMS deregistration response deletes the MBMS bearer context 422 corresponding to the TMGI which has been included in the MBMS deregistration request (S708).

The SGSN 30 confirms an NB (or identifier of an NB) in the distribution list in the MBMS bearer context 322, and in the event that an NB is registered, completes the present processing.

On the other hand, in the event that all of the NBs have been deleted from the distribution list in the MBMS bearer context 322 (EMPTY), the SGSN 30 transmits an MBMS deregistration request of the corresponding service to the GGSN 20 (S716). The GGSN serving as a transmission destination is determined by information of the GGSN in the MBMS bearer context 322, and with the present embodiment, the SGSN 30 transmits to the GGSN 20.

The SGSN 30 transmits the MBMS deregistration request including TMGI, service identifier, session identifier, and information of the SGSN 30 registered in the MBMS bearer context 322 to the GGSN 20.

The GGSN 20 which has received the MBMS deregistration request performs MBMS deregistration processing (S718). The GGSN 20 references TMGI included in the MBMS deregistration request received from the SGSN 30 to delete the SGSN 30 from the distribution list of the corresponding MBMS bearer context 222.

Next, the GGSN 20 performs session stop processing (S720). Here, in the event that bearer resources are allocated to a service identified by TMGI between the SGSN 30 and the GGSN 20, the GGSN 20 releases the bearer resources thereof. Further, in the event that the status information in the MBMS bearer context 222 is active, the GGSN 20 sets this to standby.

Next, the GGSN 20 transmits an MBMS deregistration response to the SGSN 30 (S722). The SGSN 30 which has received the MBMS deregistration response deletes the MBMS bearer context 322 corresponding to the TMGI which has been included in the MBMS deregistration request (S716).

The GGSN 20 confirms an SGSN (or identifier of an SGSN) in the distribution list in the MBMS bearer context 222, and in the event that an SGSN is registered, completes the present processing.

On the other hand, in the event that all of the SGSNs have been deleted from the distribution list in the MBMS bearer context 222 (EMPTY), the GGSN 20 transmits an MBMS deregistration request of the corresponding service to the BM-SC 10 (S724). The BM-SC serving as a transmission destination is determined by information of the BM-SC in the MBMS bearer context 222, and with the present embodiment, the GGSN 20 transmits to the BM-SC 10.

The GGSN 20 transmits the MBMS deregistration request including TMGI, service identifier, session identifier, and information of the GGSN 20 registered in the MBMS bearer context 222 to the BM-SC 10.

The BM-SC 10 which has received the MBMS deregistration request performs MBMS deregistration processing (S726). The BM-SC 10 references TMGI included in the MBMS deregistration request received from the GGSN 20 to delete the GGSN 20 from the distribution list of the corresponding MBMS bearer context 124.

Next, the BM-SC 10 performs session stop processing (S728). Here, in the event that bearer resources are allocated to a service identified by TMGI between the GGSN 20 and the BM-SC 10, the BM-SC 10 releases the bearer resources thereof. Further, in the event that the status information in the MBMS bearer context 124 is active, the BM-SC 10 sets this to standby.

Next, the BM-SC 10 transmits an MBMS deregistration response to the GGSN 20 (S730). The GGSN 20 which has received the MBMS deregistration response deletes the MBMS bearer context 222 corresponding to the TMGI which has been included in the MBMS deregistration request (S724).

The BM-SC 10 deletes the MBMS bearer context 124 identified by TMGI which has been included in the MBMS deregistration request.

According to the above procedure, MBMS registration can effectively be cancelled using the counting function by the NB 40, and also session stop can be performed. With the MBMS deregistration procedure of the NB 40, it can be detected by the counting procedure that distribution of a broadcast service for each MBMS bearer that can be identified by TMGI or the like is unnecessary.

Further, as with a case where the user is prevented from viewing due to inactivation of an application or the like, the MBMS deregistration procedure may also be started by detecting that the user is not viewing. The MBMS deregistration procedure may be started, triggered by this detection.

In this manner, each device recognizes that a service to be registered is in the broadcast mode, the BM-SC 10 registers broadcast in the mode of the MBMS bearer context 124, the GGSN 20 registers broadcast in the mode of the MBMS bearer context 222, the SGSN 30 registers broadcast in the mode of the MBMS bearer context 322, and the NB 40 registers broadcast in the mode of the MBMS bearer context 422.

Thus, in the event of determining MBMS deregistration, MBMS registration can be cancelled when the modes are the broadcast mode with reference to each of the MBMS bearer context 124 at the BM-SC 10, the MBMS bearer context 222 at the GGSN 20, the MBMS bearer context 322 at the SGSN 30, and the MBMS bearer context 422 at the NB 40.

Further, in the above case, in the event that the status information in each of the MBMS bearer context 124 at the BM-SC 10, the MBMS bearer context 222 at the GGSN 20, the MBMS bearer context 322 at the SGSN 30, and the MBMS bearer context 422 at the NB 40 is active, the status information is changed to standby, whereby session stop, broadcast data distribution, and reception stop can be performed.

Specifically, at the time of transmission of a broadcast MBMS deregistration request (S708), in the event that the mode of the MBMS bearer context 422 is broadcast, the NB 40 performs transmission of an MBMS deregistration request, MBMS deregistration processing, release of an MBMS bearer, broadcast data distribution, or reception stop.

At the time of transmission of a broadcast MBMS deregistration request (S716), in the event that the mode of the MBMS bearer context 322 is broadcast, the SGSN 30 performs transmission of an MBMS deregistration request, MBMS deregistration processing, release of an MBMS bearer, broadcast data distribution, or reception stop.

At the time of transmission of a broadcast MBMS deregistration request (S724), in the event that the mode of the MBMS bearer context 222 is broadcast, the GGSN 20 performs transmission of an MBMS deregistration request, release of an MBMS bearer, broadcast data distribution, or reception stop.

At the time of reception of a broadcast MBMS deregistration request (S724), in the event that the mode of the MBMS bearer context 222 is broadcast, the BM-SC 10 performs MBMS deregistration processing, release of an MBMS bearer, or broadcast data distribution stop.

Heretofore, though it has been stipulated that MBMS registration is cancelled under the initiative of a base station device (NB), in the event that necessity/unnecessity of reception of a mobile station device (UE) has been confirmed at the base station device (NB) and unnecessity of distribution has been able to be detected, MBMS registration has not been able to be effectively cancelled.

According to the present embodiment, a base station device (NB) can perform the MBMS deregistration procedure and session stop procedure based on a result of necessity/unnecessity of reception of a mobile station device (UE). Also, a distribution destination device can be deleted from the distribution destination list, and also releasing of resources conventionally performed with a session stop, can be performed by the MBMS deregistration procedure alone. Further, the session stop procedure necessary for session stop can be omitted.

Also, at the time of MBMS deregistration, in the event that the session is not stopped, unless MBMS registration is performed again by performing MBMS deregistration and also session stop, the session is not started.

For example, with a conventional technique, only a procedure to stop a session from a distribution source to a distribution destination has been stipulated, and session stop from a distribution destination to a distribution source has been unavailable. That is to say, request for a session stop from a base station device to a distribution source has been unavailable. Further, even if the procedure is expanded so as to request session stop from a base station to a distribution source, a device which has received a session stop request can stop distribution and temporarily release the resources, but deletion of a distribution list is not performed.

Accordingly, for example, 1) in a state in which a session has been started, 2) in an event that a session alone has been stopped under the initiative of the NB, 3) after all of sessions have been stopped under the initiative of the BM-SC, 4) in the event that all of sessions have been resumed under the initiative of the BM-SC, communication resources have been allocated to all of nodes (GGSN, SGSN, NB) included in the distribution list, and consequently, even a session stopped under the initiative of the NB has also been resumed, which has been a problem.

However, updating of a distribution destination device has been performed from the distribution list by the MBMS deregistration procedure, and for example, in the event that a session has been resumed under the initiative of the BM-SC as with 4) as well, an unnecessary session is prevented from being started.

According to the present embodiment, a session is not unnecessarily started, and accordingly, exchange of control information necessary at the time of starting a session can be reduced, and communication resources can effectively be utilized without ineffectively using communication resources necessary for the session start procedure.

Also, at the time of performing MBMS deregistration, in the event that the session is not stopped, unless MBMS registration is performed again by performing session stop along with MBMS deregistration, the session is not started. For example, heretofore, 1) in a state in which a session has been started, 2) in an event that a session alone has been stopped under the initiative of the NB, 3) after all of sessions have been stopped under the initiative of the BM-SC, 4) in the event that all of sessions have been resumed under the initiative of the BM-SC, communication resources have been allocated to all of nodes (GGSN, SGSN, NB) included in the distribution list, and consequently, even a session stopped under the initiative of the NB has also been resumed.

With the present embodiment, according to MBMS deregistration, 3) after all of sessions have been stopped under the initiative of the BM-SC, 4) in the event that all of sessions have been resumed under the initiative of the BM-SC as well, an unnecessary session is prevented from being started, which enables communication resources to be effectively utilized without communication resources being unnecessarily employed.

Also, an unnecessary session is prevented from being started, and accordingly, exchange of control information necessary at the time of starting a session can be reduced, and communication resources can effectively be utilized without communication resources necessary for the session start procedure being ineffectively employed.

[3. Modification]

The embodiments of the present invention have been described in detail with reference to the drawings so far, but a specific configuration is not restricted to these embodiments, design and so forth in a range without departing from essence of the present invention are also encompassed in Claims.

Also, a program which operates at each device in the embodiments is a program which controls the CPU and so forth (program causing a computer to function) so as to realize the functions of the above embodiments. Information handled in these devices is temporarily stored in a temporary storage device (e.g., RAM) at the time of processing thereof, and thereafter stored in a storage device such as various types of ROM or an HDD storage device, and is read out by the CPU as appropriate, and correcting or writing is performed.

Now, examples of a recoding medium in which the program is stored include semiconductor media (e.g., ROM, nonvolatile memory card, etc.), optical recording media/magneto-optical recoding media (e.g., DVD (Digital Versatile Disc), MO (Magneto Optical Disc), MD (Mini Disc), CD (Compact Disc), BD, etc.), and magnetic recording media (e.g., magnetic tape, flexible disk, etc.). Also, not only the functions of the above embodiments are realized by executing a loaded program, but also the functions of the present invention may be realized by performing processing in a collaboration with an operating system or another application program or the like based on instructions of the program thereof.

In order to distribute the program to the market, the program may be distributed by being stored in a portable recording medium, or may be transferred to a server computer connected via a network such as the Internet or the like. In this case, it goes without saying that a storage device of the server computer is also encompassed in the present invention.

Also, a part or all of the devices in the above embodiments may typically be realized as an LSI (Large Scale Integration) which is an integrated circuit. Each function block of each device may individually be converted into a chip, or a part or all may be integrated so as to obtain a chip. Also, a technique for conversion into an integrated circuit is not restricted to an LSI, and there may be realized by a dedicated circuit or general-purpose processor. Also, it goes without saying that in the event that a technique for conversion into an integrated circuit alternative to an LSI emerges due to progress of semiconductor technology, the integrated circuit according to this technology may be employed.

### REFERENCE SIGNS LIST BM-SC

100 control unit
110 transmission/reception unit
120 storage unit
122 MBMS service DB
124 MBMS bearer context
126 MBMS UE context
20 GGSN
200 control unit
210 transmission/reception unit
220 storage unit
222 MBMS bearer context
224 upstream control node DB
226 MBMS UE context
30 SGSN
300 control unit
310 transmission/reception unit
320 storage unit
322 MBMS bearer context
324 MBMS UE context
40 NB
400 control unit
410 transmission/reception unit
420 storage unit
422 MBMS bearer context
424 radio frame information
426 MBMS UE context
50 UE

1-17. (canceled)

18. A base station device to be connected to a mobile communication system configured to perform multicast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established,
wherein information of an MBMS bearer which allocates and establishes MBMS bearer resources is included in an MBMS bearer context in the MBMS bearer service;
and wherein the base station device transmits to the SGSN an MBMS deregistration request for multicast data to be transmitted in the event that there is no mobile station device needing multicast data distribution.

19. A base station device to be connected to a mobile communication system configured to perform broadcast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established,
wherein information of an MBMS bearer which allocates and establishes MBMS bearer resources is included in an MBMS bearer context in the MBMS bearer service;
and wherein the base station device transmits a confirmation message including a service identifier to the mobile station device, counts the number of mobile station devices needing broadcast data distribution, based on a response from the mobile station device, and in the event that the counted number is 0, transmits an MBMS deregistration request for the broadcast data to the SGSN.

20. A mobile station device in a mobile communication system configured to perform multicast data distribution by MBMS (Multimedia Broadcast/Multicast Service) bearer service from a BM-SC (Broadcast Multicast Service Center) to a mobile station device to be connected to a base station device via a GGSN (Gateway GPRS Support Node) and an SGSN (Serving GPRS Support Node) where an MBMS bearer has been established,
wherein the mobile station device receives a confirmation message including a service identifier from the base station device, transmits a response as to the confirmation message, informs by transmission of the response that reception of multicast data is necessary, and requests the SGSN to avoid transmitting an MBMS deregistration request.

21. The mobile station device according to claim 20, wherein the service identifier includes a TMGI (Temporary Mobile Group Identity).
